(19) United States
(12) Patent Application Publication
(10) Pub. No.: US 2026/0362572 A1
(43) Pub. Date: Nov. 12, 2026

(54) MODULAR LIGHTING FIXTURE AND CONTROLLER THEREFOR, LIGHTING EFFECT SIGNAL GENERATION METHOD, AND LIGHTING EFFECT PLAYING METHOD

(71) Applicant: Shenzhen Qianyan Technology LTD, Shenzhen (CN)

(72) Inventors: Ruiming WANG, Shenzhen (CN); Wenlong WU, Shenzhen (CN)

(21) Appl. No.: 19/672,547

(22) Filed: May 8, 2026

Related U.S. Application Data
(63) Continuation of application No. PCT/CN2024/127473, filed on Oct. 25, 2024.

(30) Foreign Application Priority Data
Oct. 27, 2023 (CN) 202311403275.5
Oct. 27, 2023 (CN) 202311403305.2

(51) Int. Cl. H05B 47/155; H05B 45/20; H05B 47/105; H05B 47/16; H05B 47/175; H05B 47/19

(52) U.S. Cl. CPC H05B 47/155; H05B 45/20; H05B 47/105; H05B 47/16; H05B 47/19; H05B 47/198

(57) ABSTRACT

The present disclosure relates to a modular lighting fixture, a lighting effect signal generation method, and a lighting effect playing method. The lighting effect signal generation method comprises: acquiring a lighting effect application package, which comprises lighting effect control parameters corresponding to a plurality of layers; on the basis of a topological order relationship represented by a light-emission unit mapping table, converting the lighting effect control parameter of each layer into timing control data; and outputting the timing control data to each lamp block of the modular lighting fixture, so as to generate a light emission signal.

### CROSS-REFERENCE TO RELATED APPLICATIONS

This application is a continuation of International Application No. PCT/CN2024/127473, filed on Oct. 25, 2024, which claims priority to Chinese Patent Application No. 202311403275.5, filed on Oct. 27, 2023, and to Chinese Patent Application No. 202311403305.2, filed on Oct. 27, 2023, all of which are hereby incorporated by reference in their entireties.

### TECHNICAL FIELD

The present disclosure relates to the field of lighting control, and in particular, to a modular lighting fixture, a method for generating a lighting effect signal and a method for displaying a lighting effect.

### BACKGROUND OF THE DISCLOSURE

Modular lighting fixtures have functions such as information display and atmosphere decoration, and are widely used. With the continuous improvement of intelligence, their functions have also been continuously developed to meet different requirements.

In conventional technology, a typical modular lighting fixture is formed by assembling a plurality of lighting modules under the control of a controller. Each lighting module generally includes a plurality of light-emitting units capable of independently controlling corresponding LED packages to emit light. Each light-emitting unit can serve as an input terminal or an output terminal, and each lighting module is further provided with its own control circuit, so as to selectively control a plurality of light-emitting units therein to emit light. Furthermore, by arranging the light-emitting units in different regions on a lighting module, different light-emitting regions of the lighting module may be defined, such that each light-emitting region corresponds to a plurality of light-emitting units, thereby enabling light-emitting region-based control of light emission of the lighting module.

It can be seen that both the electrical structure and the control information structure of the modular lighting fixture are highly complex. In terms of the electrical structure, multi-level relationships from the lighting modules to the light-emitting regions and further to the light-emitting units exist. In terms of the control information structure, not only is it necessary to adapt to such multi-level relationships, but each light-emitting unit further involves configuration of color and timing information; furthermore, avoidance relationships between the layers may also be involved. Such a complex control information structure brings great difficulty in applying lighting effects to the modular lighting fixture, particularly in converting a lighting effect application package written according to natural language logic into control data capable of controlling the coordinated and normal operation of the respective light-emitting units in the respective lighting modules of the modular lighting fixture.

### SUMMARY

Embodiments of the present disclosure provide a modular lighting fixture, a method for generating a lighting effect signal and a method for displaying a lighting effect.

According to an aspect of the present disclosure, a method for generating a lighting effect signal is provided. The method includes:
acquiring a lighting effect application package, where the lighting effect application package includes lighting effect control parameters corresponding to a plurality of layers, and the lighting effect control parameters describe lighting effects of the corresponding layers in a tree-like multi-level data structure;
converting, according to a topological ordering relationship represented by a light-emitting unit mapping table corresponding to a modular lighting fixture, the lighting effect control parameters of each of the layers into timing control data, where the topological ordering relationship is used for characterizing a topological ordering relationship formed by respective lighting modules of the modular lighting fixture, respective light-emitting regions within each lighting module, and respective light-emitting units within each light-emitting region, according to multi-level connection relationships; and
outputting the timing control data to the respective lighting modules of the modular lighting fixture to control respective light-emitting control chips within the respective lighting modules to generate corresponding light-emitting control signals.

According to an aspect of the present disclosure, a method for displaying a lighting effect is provided. The method includes:
acquiring topological information of a modular lighting fixture, where the topological information characterizes a topological ordering relationship formed by respective lighting modules of the modular lighting fixture, respective light-emitting regions within each lighting module, and respective light-emitting units within each light-emitting region, according to multi-level connection relationships;
extending the topological information into a light-emitting unit mapping table by using the light-emitting units as data record units, and representing the topological ordering relationship in the light-emitting unit mapping table;
acquiring a lighting effect application package, where the lighting effect application package includes lighting effect control parameters corresponding to a plurality of layers, parsing the lighting effect control parameters set for the layers in the lighting effect application package into control data corresponding to each light-emitting unit, and associating the control data with corresponding data records in the light-emitting unit mapping table to acquire unit instruction tables corresponding to the layers; and
converting the unit instruction tables into timing control data with control chips of the light-emitting units as a control granularity, and transmitting the timing control data to the respective lighting modules of the modular lighting fixture to display a lighting effect.

According to another aspect of the present disclosure, a modular lighting fixture is provided. The modular lighting fixture includes a controller and a plurality of lighting modules, where the plurality of lighting modules are connected in series and then connected to the controller, and the controller is adapted to perform a lighting effect signal generation method or a lighting effect display method. The lighting effect signal generation method comprises: acquiring a lighting effect application package, wherein the lighting effect application package comprises lighting-effect control parameters corresponding to a plurality of layers, and the lighting effect control parameters describe lighting effects of the corresponding layers in a tree-like multi-level data structure; converting, according to a topological ordering relationship represented by a light-emitting unit mapping table corresponding to a modular lighting fixture, the lighting effect control parameters of each of the layers into timing control data, wherein the topological ordering relationship is used for characterizing a topological ordering relationship formed by respective lighting modules of the modular lighting fixture, respective light-emitting regions within each lighting module, and respective light-emitting units within each light-emitting region, according to multi-level connection relationships; outputting the timing control data to the respective lighting modules of the modular lighting fixture to control respective light-emitting control chips within the respective lighting modules to generate corresponding light-emitting control signals. The lighting effect display method comprises: acquiring topological information of a modular lighting fixture, wherein the topological information characterizes a topological ordering relationship formed by respective lighting modules of the modular lighting fixture, respective light-emitting regions within each lighting module, and respective light-emitting units within each light-emitting region, according to multi-level connection relationships; extending the topological information into a light-emitting unit mapping table by using the light-emitting units as data record units, and representing the topological ordering relationship in the light-emitting unit mapping table; acquiring a lighting effect application package, wherein the lighting effect application package comprises lighting effect control parameters corresponding to a plurality of layers, parsing the lighting effect control parameters set for the layers in the lighting effect application package into control data corresponding to each light-emitting unit, and associating the control data with corresponding data records in the light-emitting unit mapping table to acquire unit instruction tables corresponding to the layers; and converting the unit instruction tables into timing control data with control chips of the light-emitting units as a control granularity, and transmitting the timing control data to the respective lighting modules of the modular lighting fixture to display a lighting effect.

### BRIEF DESCRIPTION OF THE DRAWINGS

FIG. 1 is a schematic diagram of an electrical structure of a modular lighting fixture in accordance with some embodiments.

FIG. 2 is a schematic flowchart of a method for generating a lighting effect signal in accordance with some embodiments.

FIG. 3 is a schematic flowchart of generating a lighting effect application package based on topological information in accordance with some embodiments.

FIG. 4 is a schematic flowchart of acquiring topological information of a modular lighting fixture in accordance with some embodiments.

FIG. 5 is a schematic flowchart of constructing a light-emitting unit mapping table based on topological information in accordance with some embodiments.

FIG. 6 is a schematic flowchart of constructing a unit instruction table based on a light-emitting unit mapping table and generating timing control data in accordance with some embodiments.

FIG. 7 is a schematic flowchart of adjusting transmission order of timing control data based on layer information and performing compression transmission in accordance with some embodiments.

FIG. 8 is a schematic flowchart of a lighting module controlling light-emitting units to display lighting effects in a coordinated manner based on timing control data in accordance with some embodiments.

FIG. 9 is a schematic flowchart of a method for displaying a lighting effect in accordance with some embodiments.

FIG. 10 is a schematic flowchart of acquiring topological information of a modular lighting fixture in accordance with some embodiments.

FIG. 11 is a schematic flowchart of constructing a light-emitting unit mapping table based on topological information in accordance with some embodiments.

FIG. 12 is a schematic flowchart of constructing a unit instruction table based on a light-emitting unit mapping table in accordance with some embodiments.

FIG. 13 is a schematic flowchart of adjusting transmission order of timing control data based on layer information in accordance with some embodiments.

FIG. 14 is a schematic flowchart of adjusting light-emitting timing information of light-emitting units in timing control data based on layer information and transmitting the timing control data in accordance with some embodiments.

FIG. 15 is a schematic flowchart of a lighting module controlling light-emitting units to display lighting effects in a coordinated manner based on timing control data in accordance with some embodiments.

FIG. 16 is a schematic structural diagram of a computer device in accordance with some embodiments.

### DETAILED DESCRIPTION

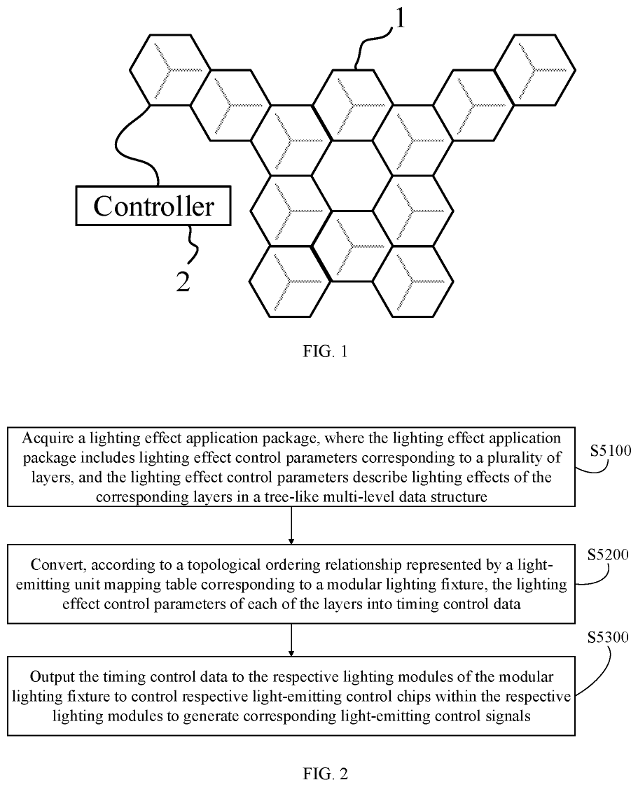

Referring to FIG. 1, the modular lighting fixture exemplarily provided in the present disclosure is formed by adjacent assembly of a plurality of lighting modules into a planar array, the entire planar array is electrically connected to a controller of the modular lighting fixture, and the controller centrally controls the entire planar array to display a lighting effect. Therefore, the controller is responsible not only for power control of each lighting module in the entire planar array, but also for instruction control of each lighting module, as well as data transmission of each lighting module. The lighting modules may have various product forms. Based on the shape of the lighting modules and the characteristics of their assembly relationships, a plurality of different forms of lighting modules may be employed to assemble the same modular lighting fixture. Optional forms include triangular, quadrilateral, pentagonal, hexagonal, and other arbitrary polygonal shapes, or radial shapes formed by any number of line segments. These shapes are suitable for arrangement on the same plane to form a certain layout. The modular lighting fixture of the present disclosure may be used as an ambient light to decorate a spatial atmosphere, and may also transmit information by forming a pattern or character through planar array light emission. Additionally, the modular lighting fixture has a certain lighting function, and is typically installed in an indoor space.

A plurality of light-emitting units are included within the lighting modules of the modular lighting fixture. Each light-emitting unit may further be provided with a corresponding light-emitting control chip for parsing corresponding control data to generate corresponding light-emitting control signals. The light-emitting control signals are used for controlling light-emitting components, such as LED packages, in the corresponding light-emitting units to emit light according to specific light-emitting parameters. Each lighting module, as a whole, may further be provided with an independent control chip as a control unit to control the light emission of all the light-emitting units therein. The independent control unit can transmit corresponding timing control data to the control chip of each light-emitting unit to achieve the purpose of centralized control. Alternatively, the entire lighting module may be provided with a single control chip to directly control each light-emitting unit, thereby achieving the purpose of displaying corresponding lighting effects. Such design may be flexibly implemented mainly depending on the capabilities of the control chip used for the lighting module and the light-emitting units thereof, which does not affect the inventive concept of the present disclosure. Based on these principles, for one lighting module, not only can all light-emitting units of the lighting module be uniformly controlled to emit light simultaneously, but also the control granularity can be refined to each light-emitting unit. The finer the control granularity, the more delicate the generated lighting effect.

The plurality of light-emitting units in the lighting module may be centrally managed in a partitioned manner based on positions of the light-emitting units on the display surface of the lighting module, such that a plurality of light-emitting regions are defined. Generally, the type of the light-emitting region in the lighting module may be a linear structural edge and/or a planar regular surface region. For example, in an embodiment, a radial lighting module is formed by three structural edges whose ends are connected together to form a Y shape, and the three structural edges constitute three light-emitting regions of the lighting module; in another embodiment, a quadrilateral lighting module is equally divided into four regular surface regions to constitute four light-emitting regions; and in another more comprehensive embodiment, a hexagonal lighting module is divided into three diamond-shaped regular surface regions, i.e., diamond-shaped blocks, and respective structural edges surrounding the three diamond-shaped blocks. Specifically, each diamond-shaped block has three structural edges, such that, from a global perspective of the entire lighting module, the lighting module includes six peripheral structural edges and three structural edges that generally form a Y shape and separate the three diamond-shaped blocks. Therefore, each diamond-shaped block or each structural edge constitutes an independent light-emitting region. In the various distributions of light-emitting regions described above, each light-emitting region is provided with one or more light-emitting units. Thus, the light-emitting regions and the light-emitting units arranged therein can be determined, and subsequent centralized control of the respective light-emitting units can be performed in units of light-emitting regions.

Lighting modules 1 of different lighting module forms can be assembled with one another. For example, a quadrilateral lighting module may be adjacently assembled at any one of the peripheral structural edges of a hexagonal lighting module. It can be readily understood that, by combining lighting modules of different forms, more diverse planar array patterns can be constructed.

To facilitate connection with other lighting modules 1, each lighting module 1 is provided, at the structural edges presented by the peripheral contour of its geometric shape, with corresponding connection interfaces. These connection interfaces include electrical interfaces, and may further include mounting interfaces. The mounting interfaces and the electrical interfaces may be combined into a single electrical interface. A user sequentially assembles different lighting modules 1 via the connection interfaces to form a desired topological configuration, such that a modular lighting fixture having a corresponding planar array pattern can be assembled. Different planar array patterns can naturally be formed by assembly according to different adjacency relationships. The electrical interfaces are mainly configured to transmit power, data, instructions, and the like. The control unit in a lighting module that performs unified control can determine whether a connection relationship exists at each structural edge by detecting input/output states of the electrical interfaces corresponding to the respective structural edges of the lighting module. Structural edges connected to other lighting modules are identified as connected edges, while structural edges not connected to other lighting modules are identified as unconnected edges. For a connected edge, the corresponding connection interface is in fact an output or input interface of one light-emitting unit in the structural edge. Therefore, by detecting the connection state of each connection interface, particularly the electrical interfaces thereof, whether the lighting module is connected to other lighting modules can be determined.

The respective lighting modules in the modular lighting fixture can establish communication connections with the controller by complying with the same data communication protocol. Generally, the controller is connected to one or more first lighting modules, and other lighting modules are sequentially connected to the previously connected lighting modules. The same lighting module may be connected to a plurality of other lighting modules through a plurality of structural edges of the lighting module, thereby extending a plurality of branches. By analogy, it can be readily understood that the connection relationships of the entire planar array may form a tree-like connection topology. Starting from the first lighting module connected to the controller, the first lighting module serves as a root node in the tree-like topology, and a path extending to each leaf node of the tree-like topology may be regarded as one and the same branch chain. The controller may support constructing a plurality of such branch chains on demand. Instructions and data sent by the controller may be transmitted downstream along the branch chain to reach the control units of the respective lighting modules. Conversely, the respective lighting modules may also transmit their own data and instructions upstream along the branch chain to the controller. Generally, the lighting modules in each branch chain process instructions and data corresponding to themselves according to a standardized data communication protocol, and meanwhile perform upstream and downstream relay functions for other upstream and downstream lighting modules along the branch chain. It can be readily understood that, by identifying the connected edges and unconnected edges of each lighting module in the same branch chain to determine the connection position of the lighting module, and further by referring to the hierarchical order of the lighting module within the entire branch chain to determine the sequential position of the lighting module in the entire branch chain, the planar array pattern of the entire branch chain can be identified, which correspondingly describes the assembled shape of the entire branch chain. By analogy, when a plurality of branch chains exist, the planar array patterns of the plurality of branch chains together constitute the entire planar array pattern of the entire modular lighting fixture, corresponding to the assembled shape of the entire modular lighting fixture.

For example, FIG. 1 illustrates a modular lighting fixture formed by assembling a plurality of lighting modules 1 having a regular hexagonal structure. Each lighting module 1 includes a plurality of light-emitting units. These light-emitting units are distributed in respective diamond-shaped blocks of the regular hexagonal structure, respective structural edges, and/or structural edges between the respective diamond-shaped blocks. Therefore, light emission control at different granularities can be implemented for each lighting module 1. For example, the respective diamond-shaped blocks, the respective structural edges, or individual light-emitting units therein may be independently controlled, or all light-emitting units within the lighting module 1 may be integrally controlled.

For a controller 2 in the modular lighting fixture, the controller 2 generally includes a control chip, a communication component, and the like, and is configured to implement operational control of the entire modular lighting fixture, as well as to be responsible for communication inside and outside the modular lighting fixture. For example, the controller is configured to collect connection state information of the respective lighting modules, transmit timing control data to the respective lighting modules, and perform data communication with external devices with respect to functions such as installation, detection, and lighting effect display. The external devices in communication with the controller may be terminal devices of any form, such as mobile phones, tablet computers, personal computers, and remote controllers, on which corresponding application programs are installed and executed. The application programs installed and executed on the terminal devices are adapted to communicate with the controller to implement various functions.

The control chip in the controller, the control chip serving a unified control function in the control unit of each lighting module, the control chips used in the respective light-emitting units within the lighting module, and the like may all be implemented by various embedded chips. For example, Bluetooth System on Chips (SoCs) with built-in communication components, WiFi SoCs, micro controller units (MCUs) additionally provided with communication components, and digital signal processing chips (DSPs) may be employed. The control chip generally includes a central processor and a memory, and is mainly configured to store and execute program instructions so as to implement corresponding functions. The communication component may be configured to perform wireless or wired communication with external devices. For example, the control chip in the controller may communicate with various intelligent terminal devices such as personal computers and smart phones, such that a user can transmit a lighting effect application package to the modular lighting fixture via the terminal device, for generating timing control data corresponding to lighting effects and transmitting the timing control data to the respective lighting modules in the modular lighting fixture.

After receiving the lighting effect application package via the communication component, the control chip can correspondingly parse the lighting effect application package into timing control data for controlling the respective light-emitting units of the modular lighting fixture, and output the timing control data to the respective lighting modules 1, so as to control the corresponding light-emitting units in the respective lighting modules 1 to display lighting effects in a coordinated manner.

In some embodiments, the controller 2 may further be configured with a power adapter, a control panel, a display screen, and the like as required. The power adapter is mainly configured to convert mains power into direct current to supply power to the entire modular lighting fixture. The control panel generally provides one or more buttons for implementing power-on/off control and the like over the controller 2. The display screen can be configured to display various control information, so as to cooperate with the buttons on the control panel to support implementation of human-machine interaction functions. In some embodiments, the control panel may be integrated with the display screen into a single touch display screen.

The method for generating a lighting effect signal and the method for displaying a lighting effect according to the present disclosure may be divided into steps corresponding to the controller and the lighting modules, respectively, and implemented as corresponding computer program products. The computer program products are correspondingly installed and executed in the control chip of the controller of the modular lighting fixture and the control chips of the lighting modules, such that the controller controls the respective lighting modules to display corresponding lighting effects in a coordinated manner according to the lighting effect application package.

Referring to FIG. 2, in one embodiment, the method for generating a lighting effect signal according to the present disclosure includes the following steps:

In step S5100, a lighting effect application package is acquired, where the lighting effect application package includes lighting effect control parameters corresponding to a plurality of layers, and the lighting effect control parameters describe lighting effects of the corresponding layers in a tree-like multi-level data structure.

The lighting effect application package is mainly used for defining the lighting effect control parameters corresponding to one or more layers of a lighting effect, and the lighting effect displayed by the modular lighting fixture is described through the lighting effect control parameters. In the present disclosure, the lighting effect application package can be converted into timing control data corresponding to the respective lighting modules in the modular lighting fixture.

The lighting effect application package may be transmitted from a terminal device to the controller and stored by the controller in a local memory. Alternatively, a lighting effect application package already stored in the memory may be directly called. The lighting effect application package may first be acquired and then parsed to obtain various lighting effect control parameters defined therein that correspond to the lighting effect. For example, the lighting effect control parameters include layer information for specifying corresponding layers, region information for specifying light-emitting regions of the lighting modules, and lighting effect information for specifying light-emitting units within corresponding light-emitting regions to emit light according to specific parameters.

The lighting effect application package of the present disclosure may be represented in a manner of computer program objects, where the lighting effect control parameters of all layers of the lighting effect are described as a class, thereby implementing description of the lighting effect control parameters corresponding to the respective layers by using a tree-like multi-level data structure of the class. Representing the lighting effect application package in this manner allows combination with computer programming so as to reflect advantages of data structures, and facilitates efficient generation and access to various attribute items and corresponding attribute values of the class during programming. According to such a structure, layer information, region information, lighting effect information, and the like may all be represented as attribute data corresponding to the second level, the third level, or further levels in the multi-level data structure. Organizing various complex attribute items of lighting effects by using a tree-like multi-level data structure not only enables efficient organization of lighting effect control parameters, but also facilitates efficient interface presentation so as to improve user editing efficiency.

In step S5200, according to a topological ordering relationship represented by a light-emitting unit mapping table corresponding to the modular lighting fixture, the lighting effect control parameters of each of the layers are converted into timing control data. The topological ordering relationship characterizes topological relationships among the lighting modules of the modular lighting fixture, among the respective light-emitting regions within each lighting module, and among the light-emitting control chips of each light-emitting region.

According to the present disclosure, when the modular lighting fixture is controlled to display lighting effects, it is necessary to specifically provide each light-emitting unit in each lighting module with corresponding control data for controlling how the light-emitting unit emits light. That is, in the present disclosure, the control of lighting effects is specifically performed at a control granularity using the light-emitting unit as a basic unit. However, original topological information corresponding to the topological ordering relationship of the modular lighting fixture itself is represented by multi-level connection relationships, which leads to a problem of how to implement efficient data conversion. Therefore, in the present disclosure, a light-emitting unit mapping table is created by the controller for lighting effect conversion of the modular lighting fixture. The light-emitting unit mapping table is used for implementing a two-dimensional conversion representation of the topological ordering relationship of concatenated information of the modular lighting fixture, so as to store the topological ordering relationship corresponding to the respective light-emitting units.

Specifically, to facilitate the conversion of the lighting effect control parameters of each layer in the lighting effect application package into the corresponding timing control data, the controller of the modular lighting fixture may preconfigure a light-emitting unit mapping table. The light-emitting unit mapping table represents topological relationships among the respective lighting modules in the modular lighting fixture, among the respective light-emitting regions of each lighting module, and among the light-emitting control chips of the respective light-emitting units within each light-emitting region, such that an overall topological ordering relationship is acquired. According to such a topological ordering relationship, data conversion is performed on the lighting effect control parameters, such that the timing control data converted from the lighting effect control parameters can be rapidly acquired.

In the light-emitting unit mapping table, one corresponding data record is configured for each light-emitting unit in the modular lighting fixture. In an exemplary embodiment, fields such as an identity identifier and an ordering identifier of the light-emitting unit, the light-emitting region to which the light-emitting unit belongs, the lighting module to which the light-emitting unit belongs, and the ordering position of the lighting module to which the light-emitting unit belongs in the branch chain are represented in the form of attribute data in the data record. Furthermore, in other embodiments, other fields such as the ordering identifier of the light-emitting region may also be added, which may be flexibly configured as required. In summary, it can be readily understood from this example that the light-emitting unit mapping table converts complex multi-level connection relationships of the modular lighting fixture represented in topological information into more intuitive two-dimensional data records. Each data record corresponds to one light-emitting unit within one lighting module of the modular lighting fixture, thereby achieving data representation with the light-emitting units as a control granularity and facilitating subsequent further data conversion.

In an embodiment, the respective data records in the light-emitting unit mapping table may, as required, be ordered in multiple fields according to a data communication order from the controller to the control chips of the respective lighting modules, the respective regions, and the respective light-emitting units, such that all light-emitting units can be arranged in accordance with a serial signal order in the modular lighting fixture. In this way, control data corresponding to the respective light-emitting units can be directly assembled according to such an ordering relationship to generate timing control data to be transmitted to the respective lighting modules, thereby achieving higher conversion efficiency.

Once established, the light-emitting unit mapping table can be reused subsequently. Thus, the controller may store the light-emitting unit mapping table in its memory for subsequent use. When the assembly relationship among the lighting modules in the modular lighting fixture changes, a new light-emitting unit mapping table may be regenerated; otherwise, if only a new lighting effect application package is applied, the original light-emitting unit mapping table can be directly called.

In an embodiment, the region information of the lighting effect application package generally only needs to define the light-emitting regions corresponding to each lighting module, and generally does not need to specify light-emitting units. In the controller, by means of the mapping relationship between the light-emitting regions and the light-emitting units in the preconfigured light-emitting unit mapping table, the light-emitting units of the respective lighting modules corresponding to the effective light-emitting regions specified by each piece of region information can be rapidly determined.

The various lighting effect control parameters of each layer described above may be converted into control data corresponding to each light-emitting unit within each lighting module in the modular lighting fixture, and associated with corresponding data records in the light-emitting unit mapping table, such that, for each layer, a corresponding unit instruction table is acquired.

For example, the layer information in the lighting effect control parameters mainly indicates a relative displaying relationship among the respective layers, such as sequential display of the respective layers or synchronous display of some layers. Correspondingly, in the time domain, the layer information of the current layer defines the display timing and/or display duration of the layer. Therefore, the layer information further defines, for the current layer, the display timing and/or display duration of the respective light-emitting units of the modular lighting fixture. Accordingly, corresponding light-emitting timing information of the respective light-emitting units in the light-emitting unit mapping table can be configured based on the layer information.

The region information in the lighting effect control parameters mainly indicates, in the current layer, which one or more light-emitting regions of each lighting module are responsible for emitting light or not emitting light, which is generally determined by specifying effective light-emitting regions of the lighting module. Accordingly, for whether the light-emitting regions corresponding to the respective light-emitting units in the light-emitting unit mapping table belong to the effective light-emitting regions, the respective light-emitting units can be correspondingly marked, so as to indicate whether the corresponding light-emitting unit works or does not work, or to indicate whether the corresponding light-emitting unit emits light in a default manner or emits light based on specified lighting effect information.

The lighting effect information in the lighting effect control parameters mainly indicates, in the current layer, how the respective effective light-emitting regions of the respective lighting modules within the entire planar array pattern range of the modular lighting fixture emit light in a coordinated manner to present corresponding motion effects, that is, the lighting effect information indicates a lighting effect motion process corresponding to the current layer. Therefore, the lighting effect information generally includes motion parameters, light-emitting color parameters, light-emitting duration, and the like, which may be provided as required. These parameters specifically affect light-emitting control of the LED packages of each light-emitting unit. Therefore, it is necessary to determine, based on the lighting effect information and in accordance with preset calculation service logic, various specific parameters corresponding to each light-emitting unit, such as light-emitting timing information, light-emitting color information, and even light-emitting duration information, and to respectively associate these specific parameters with the corresponding light-emitting units in the light-emitting unit mapping table. For time-related parameters of the light-emitting units, such as the light-emitting timing information and the light-emitting duration information, since such parameters may be constrained by display timing and/or display duration corresponding to the layer to which the light-emitting units belong, such parameters may be determined in coordination with the display timing and/or display duration of the layer.

It can be seen that after the lighting effect control parameters of each layer are correspondingly converted and associated with the corresponding light-emitting units in the light-emitting unit mapping table according to the above principles, the light-emitting unit mapping table is thus extended to obtain a unit instruction table corresponding to each layer. Each unit instruction table includes distribution information of the light-emitting units in a hardware structure, timing information of the light-emitting units in an electrical control structure, corresponding attribute information indicating the light emission of the light-emitting units, and the like. All data related to the operation of each light-emitting unit are extended into one-dimensional data in the data records, and all lighting effect control parameters corresponding to the entire layer are also extended into two-dimensional data represented by the data records corresponding to the respective light-emitting units in the unit instruction table. It can be seen that this representation is convenient, intuitive and efficient, and more convenient for corresponding conversion, which can improve the conversion efficiency of converting the lighting effect control parameters in the lighting effect application package into corresponding timing control data.

After processing through the above process, it can be readily understood that each layer in the lighting effect application package can acquire a corresponding unit instruction table. In the unit instruction table, control data required by each light-emitting unit in the entire modular lighting fixture to perform light emission control are represented by respective data records, and the data of the respective fields in each data record can be configured as the control data. Accordingly, the control data of each light-emitting unit is used as a basic unit, and the timing control data corresponding to the current layer can be acquired by orderly concatenating the control data of each light-emitting unit based on the light-emitting timing information corresponding to the respective lighting modules, the light-emitting regions corresponding to each lighting module, and the respective light-emitting units within each light-emitting region. From the perspective of the light-emitting units, the timing control data is represented as a one-dimensional serialized data structure, in which the light-emitting unit serves as a basic control granularity.

In addition, in other embodiments, provided that the control chip of the controller and the light-emitting control chip of the light-emitting unit can mutually recognize the protocol, the timing control data may also be represented as a non-serialized data structure. For example, only addressing information and corresponding control data of the light-emitting unit that needs to change relative to the previous frame are provided, thereby reducing the overall amount of data transmission when the controller displays multiple frames of lighting effects.

In step S5300, the timing control data are outputted to the respective lighting modules of the modular lighting fixture to control respective light-emitting control chips within the respective lighting modules to generate corresponding light-emitting control signals.

The timing control data corresponding to the respective layers acquired through the above process may be transmitted to the respective lighting modules for application. When the timing control data are transmitted to the respective lighting modules in the branch chain, each lighting module may sequentially extract the timing control data corresponding to itself to implement the light emission control of the lighting module. When the lighting module transmits the extracted timing control data corresponding to itself to the respective light-emitting units, each light-emitting unit may also extract the control data corresponding to itself to implement the light emission control on its own LED packages, and the control chip of the light-emitting unit, i.e., the light-emitting control chip, converts the corresponding control data into light-emitting control signals to control the LED packages in the light-emitting unit to emit light accordingly. Through this mechanism, the corresponding light-emitting units in the entire modular lighting fixture are capable of controlling the corresponding LED packages to emit light in a coordinated manner under the action of their own corresponding control data, thereby presenting corresponding lighting effects.

In an embodiment, for the unit instruction tables corresponding to the plurality of layers, the controller may sequentially convert the timing control data corresponding to the respective layers according to the order of the layers and transmit the timing control data to the corresponding lighting modules. In another embodiment, all unit instruction tables corresponding to the plurality of layers may also be converted at one time and transmitted to the corresponding lighting modules in a unified manner, provided that the control units of the respective lighting modules implement corresponding parsing and execute corresponding service logic in advance.

In some embodiments, data compression may be performed on each piece of timing control data before transmission to the lighting modules. For example, the control data of the respective light-emitting units belonging to the same lighting module are clustered and concatenated based on the light-emitting regions or the lighting modules, such that the control data of different light-emitting units share the same data, which can subsequently be correspondingly parsed by the respective lighting modules. Alternatively, in other embodiments, various region identifiers and identity identifiers are represented by concise binary addresses, and timing relationships are represented by ordering relationships, such that data compression can also be achieved. After compression, the number of bytes of all timing control data is reduced, and the control chips used by the control units of the respective lighting modules, the control chips used by the respective light-emitting units, and the like may be implemented by using lower-cost embedded chips, thereby effectively reducing the manufacturing cost of each lighting module and the entire modular lighting fixture. Considering the fact that each lighting module includes a large number of control chips, this clearly provides a significant cost advantage in large-scale production scenarios.

For one lighting effect application package, the controller of the modular lighting fixture only needs, upon the first application, to acquire the unit instruction tables and the corresponding timing control data of the respective layers according to the above process, and then can store the unit instruction tables and the corresponding timing control data of the respective layers for subsequent use. Thereafter, each time the system is powered on and a default call is required, or when a user instructs the controller to configure lighting effects corresponding to the lighting effect application package, the unit instruction tables and/or the timing control data are called from the memory, so as to acquire final timing control data that are required to be transmitted to the respective lighting modules. It is unnecessary to repeatedly perform steps S5100 and S5200 to generate the timing control data, thereby avoiding unnecessary re-computation.

According to the above embodiments, it can be seen that the present disclosure has various technical advantages, including but not limited to:

First, according to the present disclosure, the topological information representing the topological ordering relationship among the respective lighting modules, the respective light-emitting regions, and the respective light-emitting units of the modular lighting fixture is first acquired. When a lighting effect application package is required to be parsed and used, the topological information is first subjected to two-dimensional conversion to acquire a light-emitting unit mapping table. In the light-emitting unit mapping table, various light-emitting control information of the respective light-emitting units is converted into independent data records, such that other lighting effect control parameters of the light-emitting units, including light-emitting timing information, light-emitting color information, and the like, can be conveniently configured in units of data records. Accordingly, other lighting effect application parameters in the lighting effect application package are associated with the respective light-emitting units, such that the control data of the respective light-emitting units of the respective lighting modules in the respective layers are independently and completely established to acquire unit instruction tables. In the unit instruction tables, the relationships among the respective light-emitting units arranged in an orderly manner are acquired. Finally, according to such relationships, the unit instruction tables are further subjected to dimension reduction to acquire the timing control data corresponding to the entire modular lighting fixture. The timing control data represent, with the light-emitting units as a control granularity, various control data of the respective light-emitting units when executing lighting effects. Since the control data corresponding to a plurality of light-emitting units in the timing control data are substantially isomorphic, the timing control data are capable of being efficiently compressed. The timing control data after compression as required have a small data volume and can be transmitted efficiently. Moreover, since the timing control data correspond one-to-one with the light-emitting units of the lighting modules in a physical product, accurate display of lighting effects can be ensured, thereby improving product reliability of the modular lighting fixture.

Second, on the basis that the present disclosure can achieve efficient conversion from a lighting effect application package to time-based control instructions, on a terminal device side for customized lighting effects, various lighting effects can be edited according to natural-language logic, thereby providing a favorable user experience; and on a modular lighting fixture side, since an efficient conversion and parsing mechanism is provided, user-customized lighting effects can be rapidly understood and applied, improving lighting effect execution efficiency and undoubtedly enriching playability of the product.

In addition, modular lighting fixtures are currently in a stage of industrial promotion and development. The higher the convenience of lighting effect application, the more beneficial it is to industrial promotion of modular lighting fixtures, and the more optimistic the economic expectation will be. By providing a lighting effect conversion mechanism to improve convenience and reliability of lighting effect customization, the present disclosure improves the functions of modular lighting fixture products, and thus larger-scale economic benefits can naturally be optimistically expected.

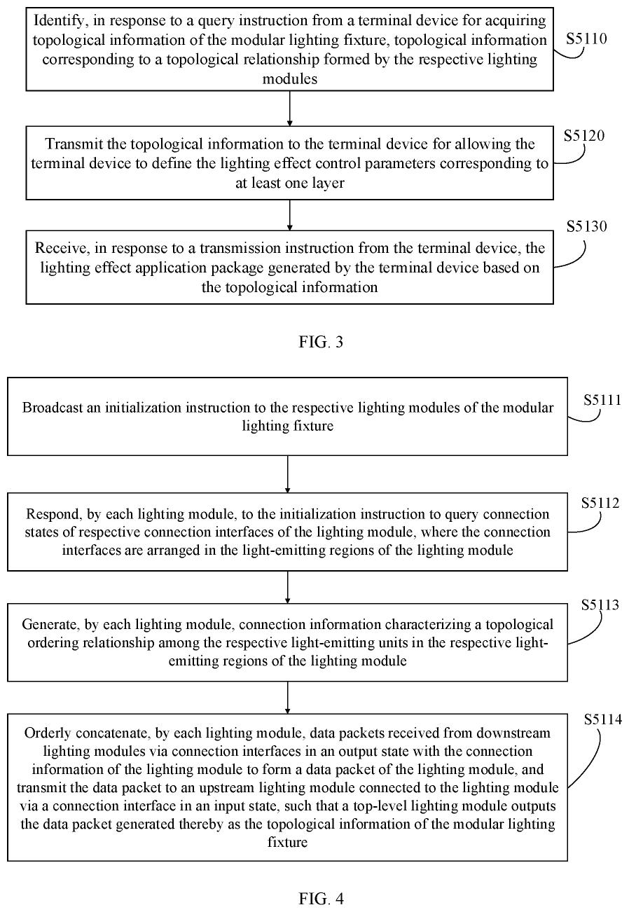

Based on any embodiment of the method of the present disclosure, referring to FIG. 3, acquiring the lighting effect application package includes the following steps:

In step S5110, in response to a query instruction from a terminal device for acquiring topological information of the modular lighting fixture, topological information corresponding to a topological relationship formed by the respective lighting modules is identified.

The controller of the modular lighting fixture may be controlled by the terminal device, and in response to a query instruction issued by the terminal device, acquire the topological information corresponding to the topological relationship formed by the respective lighting modules of the modular lighting fixture. In an embodiment, after the modular lighting fixture is assembled and started for the first time, the controller of the modular lighting fixture may, by default, execute the service logic for acquiring topological information, thereby driving the controller to identify and acquire the topological information corresponding to the topological relationship among the respective lighting modules.

The modular lighting fixture is typically installed on the facade of a physical space, and is formed by sequentially assembling the respective lighting modules and connecting them to the controller by a user. After the modular lighting fixture is assembled, topological information corresponding to the planar array pattern formed by the respective lighting modules of the modular lighting fixture can be acquired.

In terms of content, the topological information of the modular lighting fixture mainly represents the topological ordering relationship in which the lighting modules are organized according to a multi-level connection relationship, so as to provide corresponding connection positions and connection ordering of the interconnection among the respective lighting modules, which may be regarded as hierarchical ordering. The topological information further represents the light-emitting regions in which the light-emitting control chips of the respective light-emitting units in each lighting module are distributed, as well as corresponding ordering identifiers. Since the light-emitting regions are mainly used for performing partitioned management on the light-emitting units of the lighting module, through this topological ordering relationship, multi-level connection relationships formed among the respective lighting modules of the modular lighting fixture, the respective light-emitting regions within each lighting module, and the light-emitting control chips of the respective light-emitting units within each light-emitting region are represented, that is, the network topology of all the light-emitting units of all the lighting modules of the entire modular lighting fixture is described.

In some embodiments, the topological information may only include the structural forms of the lighting modules, and the controller prestores mapping relationship data corresponding to various structural forms, where the mapping relationship data define relationships between light-emitting regions and the light-emitting control chips of the light-emitting units arranged in the respective light-emitting regions. When the structural form of a certain lighting module is determined from the topological information, the mapping relationship data may be called and used as a basis for constructing the mapping relationship between the respective light-emitting units and the light-emitting regions in the light-emitting unit mapping table in subsequent steps of the present disclosure.

In terms of representation form, the topological information of the modular lighting fixture may be represented as a text file, a style file such as an XML file, or a message structure, and may be flexibly implemented, provided that it is suitable for correspondingly describing the tree-like multi-level structure formed by the network topology of the light-emitting units.

Specific parameters used in the modular lighting fixture to define the topological ordering relationship may be flexibly configured as required. For example, in some embodiments, the light-emitting region to which the light-emitting unit belongs may be defined as attribute data of the light-emitting unit; in some embodiments, each light-emitting region may be defined as an independent object, and the corresponding light-emitting units are represented as attribute data of the light-emitting region. Such cases do not affect the inventive concept of the present disclosure and are not exhaustively listed herein.

In step S5120, the topological information is transmitted to the terminal device for allowing the terminal device to define the lighting effect control parameters corresponding to at least one layer.

After the topological information of the modular lighting fixture is acquired, the topological information may be transmitted to the terminal device. The terminal device parses the topological information according to preset service logic to acquire the topological relationship among the lighting modules, and constructs, according to the topological relationship, a corresponding planar layout in the graphical user interface. The planar layout is effectively a graphical representation result of the planar array pattern of the modular lighting fixture.

Based on the planar layout, the terminal device may provide the user with a function for customizing lighting effect control parameters corresponding to one or more layers. The user may independently create layers and define, for each layer, various lighting effect control parameters, such as layer information, region information, and lighting effect information, thereby finally forming the lighting effect control parameters corresponding to the respective layers of the overall lighting effect.

In step S5130, in response to a transmission instruction from the terminal device, the lighting effect application package generated by the terminal device based on the topological information is received.

After the user completes editing of the lighting effect, a lighting effect application instruction may be issued via the terminal device. In response to the lighting effect application instruction, the terminal device packages the lighting effect control parameters corresponding to the respective layers of the lighting effect into a lighting effect application package, and then issues a transmission instruction to the controller of the modular lighting fixture. The controller, in response to the transmission instruction, starts to receive the lighting effect application package, and after completely receiving the lighting effect application package, stores the lighting effect application package in a local memory.

It can be seen from the above embodiments that the topological information used to construct the light-emitting unit mapping table may also be synchronously transmitted to the terminal device for lighting effect customization. Since both the light-emitting unit mapping table and the lighting effect control parameters generated from lighting effect customization by the user are generated based on the same topological information, accurate correspondence therebetween is ensured. Subsequently, the lighting effect control parameters in the lighting effect application package are converted according to the light-emitting unit mapping table, such that accurate application of the user-customized lighting effect can be achieved.

Based on any embodiment of the method of the present disclosure, referring to FIG. 4, identifying the topological information corresponding to the topological relationship formed by the respective lighting modules includes the following steps:

In step S5111, an initialization instruction is broadcast to the respective lighting modules of the modular lighting fixture.

To acquire the topological information of the respective lighting modules of the modular lighting fixture, the controller may broadcast an initialization instruction to the respective lighting modules, and the respective lighting modules are driven by the initialization instruction to perform self-detection, such that the respective lighting modules return their connection information to the controller.

In step S5112, each lighting module responds to the initialization instruction to query connection states of respective connection interfaces of the lighting module, where the connection interfaces are arranged in the light-emitting regions of the lighting module.

For any one lighting module that has been electrically connected to the controller, after the control chip that performs a unified control function thereof receives the initialization instruction transmitted by the controller, the lighting module, in response to the instruction, detects, via an I/O port of the control chip, connection states of connection interfaces corresponding to the respective structural edges of the lighting module. The connection states mainly include an input state, an output state, and a power-off state. The input state indicates that the lighting module is a downstream lighting module of another lighting module in the branch chain; the output state indicates that the lighting module is an upstream lighting module of another lighting module in the branch chain; and the power-off state indicates that the connection interface of the corresponding structural edge is not connected. It should be noted that the structural edge illustrated herein is essentially an independently controllable light-emitting region.

In step S5113, each lighting module generates connection information characterizing a topological ordering relationship among the respective light-emitting units in the respective light-emitting regions of the lighting module.

Through the above detection process, the control chip of each lighting module acquires the connection states of the respective connection interfaces of the lighting module, thereby identifying the connected edges and the unconnected edges in the respective structural edges of the lighting module. To satisfy the requirement for returning the connection states, in an embodiment, the connection information may be generated only based on the connection states of the connected edges. In other alternative embodiments, data corresponding to the connection states of both the connected edges and the unconnected edges may also be used to generate the connection information of the lighting module. In any case, the controller is capable of correspondingly identifying such information.

It should be noted that, since the connected edges correspond to the light-emitting regions, the connection information of the lighting module also defines the connection relationship among the light-emitting regions through the connected edges. Therefore, the connection information of the lighting module in fact also provides the electrical structure information of the lighting module itself, that is, connection relationship information among the respective light-emitting units in the respective light-emitting regions within the lighting module.

In step S5114, each lighting module orderly concatenates data packets received from downstream lighting modules via connection interfaces in an output state with the connection information of the lighting module to form a data packet of the lighting module, and transmits the data packet to an upstream lighting module connected to the lighting module via a connection interface in an input state, such that a top-level lighting module outputs the data packet generated thereby as the topological information of the modular lighting fixture.

To ensure that the respective lighting modules in each branch chain effectively return their respective connection information to the controller according to the standardized data communication protocol, each lighting module may upload its connection information along the branch chain according to a uniformly defined service logic. Specifically, for the lighting module, the connection information of its downstream lighting modules is encapsulated into the data packets and uploaded along the branch chain to the lighting module. After the lighting module generates its own connection information and acquires the entire data packet uploaded from the downstream lighting modules, the lighting module thereby acquires the connection information of itself and of its respective downstream lighting modules. To indicate the hierarchical order of the lighting module in the branch chain, the control chip of the lighting module orderly combines its own connection information with the data packets of the respective downstream lighting modules in a predetermined sequence, thereby forming a new data packet. Such combination is performed in accordance with a preset protocol format, so as to effectively indicate the hierarchical order of the lighting module in the new data packet. Thereafter, the lighting module uploads the new data packet further upward along the branch chain to an upstream lighting module. Each lighting module operates according to the aforementioned service logic. By analogy, the top-level lighting module is the first lighting module directly connected to the controller, and the first lighting module transmits the final data packet generated thereby to the controller, such that the controller acquires the connection information of all lighting modules in the branch chain. Since the data packet submitted to the controller by the top-level lighting module already represents, through a specific data structure, a multi-level connection ordering relationship among the respective lighting modules, the respective light-emitting regions, and the respective light-emitting units in the branch chain, the data packet may be regarded as the topological information of the present disclosure.

After the controller acquires the topological information returned by all lighting modules, the controller correspondingly determines the hierarchical orders of the respective lighting modules by adapting to the manner in which the hierarchical orders are indicated when the respective lighting modules return their connection information, thereby obtaining hierarchical ordering relationship information of the respective branch chains, the respective lighting modules and their light-emitting regions in each branch chain, as well as the respective light-emitting units and other objects in the entire modular lighting fixture.

It can be readily understood that, when a plurality of branch chains exist in the modular lighting fixture, the topological information of each branch chain can be acquired in the same manner, and the controller only needs to distinguish different branch chains and apply the corresponding topological information thereto.

According to the above embodiments, it can be seen that, by implementing standardized service logic in each lighting module, standardized production of the lighting modules can be achieved. By means of the effect produced by the service logic during runtime, the user may indiscriminately use arbitrary lighting modules for assembly, thereby assembling a desired planar array pattern. Regardless of the shape of the planar array pattern, each lighting module in the modular lighting fixture can accurately perceive, characterize, and transmit its own control structure information and its hierarchical order in the branch chain, as well as other multi-level connection relationship information, such that the modular lighting fixture can implement lighting effect conversion and application based on such connection relationship information.

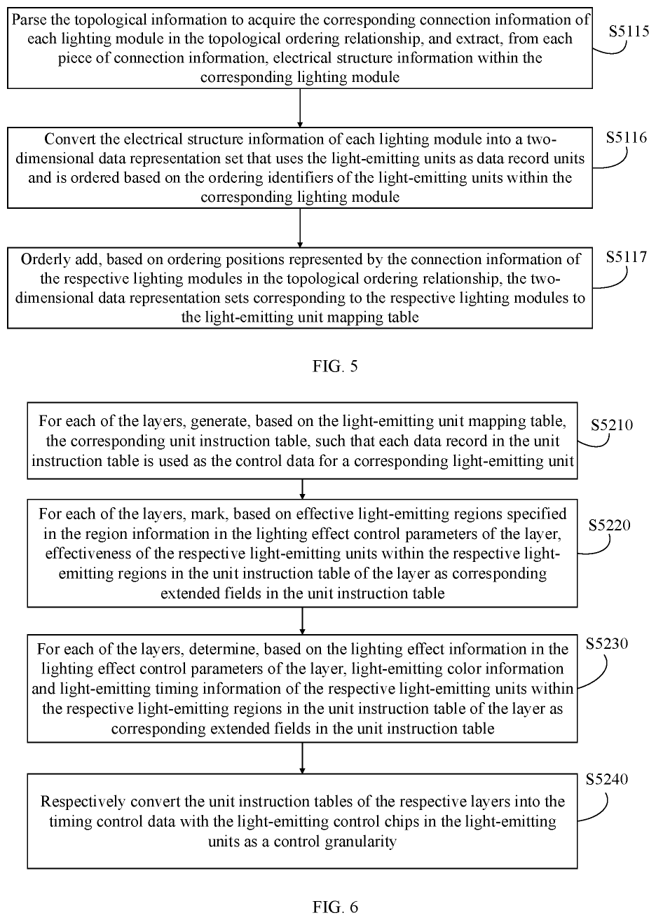

Based on any embodiment of the method of the present disclosure, referring to FIG. 5, after the top-level lighting module outputs the data packet acquired as the topological information of the modular lighting fixture, the method includes the following steps:

In step S5115, the topological information is parsed to acquire the corresponding connection information of each lighting module in the topological ordering relationship, and electrical structure information within the corresponding lighting module is extracted from each piece of connection information, where the electrical structure information includes identity identifiers and ordering identifiers of the respective light-emitting units in the lighting module, and region identifiers of the light-emitting regions to which the light-emitting units belong.

After the controller acquires the topological information of the modular lighting fixture, the controller may parse the topological information accordingly, thereby extracting the connection information corresponding to each lighting module. The connection information of each lighting module already represents the electrical structure information corresponding to the connection relationship among the respective light-emitting units covered by the respective light-emitting regions within the lighting module. In one embodiment, the electrical structure information includes the identity identifiers and the ordering identifiers of the respective light-emitting units in the lighting module, and the region identifiers of the light-emitting regions to which the light-emitting units belong. Therefore, the topological ordering relationship among the respective light-emitting regions and the respective light-emitting units within the lighting module can be acquired based on the electrical structure information of the lighting module.

In step S5116, the electrical structure information of each lighting module is converted into a two-dimensional data representation set that uses the light-emitting units as data record units and is ordered based on the ordering identifiers of the light-emitting units within the corresponding lighting module.

The modular lighting fixture is formed by assembling a plurality of lighting modules, and the respective lighting modules may differ in shape, and their electrical structure information may also differ from one another. Therefore, for each lighting module, a two-dimensional data representation set corresponding to the lighting module required for constructing a light-emitting unit mapping table may be constructed based on the electrical structure information of the lighting module. In the two-dimensional data representation set, the respective light-emitting units may be ordered according to their ordering identifiers.

Specifically, for each lighting module, the respective items of information in the electrical structure information of the lighting module, including, for example, the identity identifiers and the ordering identifiers of the respective light-emitting units, and the region identifiers of the light-emitting regions to which the light-emitting units belong, are extended into data records corresponding to the respective light-emitting units. In addition, each data record may further be extended with a field indicating the lighting module identifier of the lighting module to which the light-emitting units belong, thereby acquiring a corresponding data record for each light-emitting unit in the lighting module. All data records corresponding to all light-emitting units of the lighting module together constitute the two-dimensional data representation set of the lighting module.

In step S5117, based on ordering positions represented by the connection information of the respective lighting modules in the topological ordering relationship, the two-dimensional data representation sets corresponding to the respective lighting modules are orderly added to the light-emitting unit mapping table.

After the respective lighting modules acquire their corresponding two-dimensional data representation sets, the two-dimensional data representation sets of the respective lighting modules may be orderly added into a blank light-emitting unit mapping table according to an ordering relationship, i.e., the ordering positions of the respective lighting modules in the topological ordering relationship represented by the topological information, as indicated by the respective connection information of the lighting modules, that is, the hierarchical orders of the lighting modules in the entire branch chain, or the arrival order when the controller transmits instructions or data downstream along the branch chain. Therefore, the light-emitting unit mapping table includes the data records corresponding to all light-emitting units of all lighting modules, and the data records are arranged in an ordered manner, thereby facilitating subsequent sequential concatenation to acquire timing control data.

According to the above embodiments, it can be readily understood that the controller of the modular lighting fixture, by parsing and applying the topological information, is capable of converting topological information represented in any format into a standardized light-emitting unit mapping table, and further capable of unifying data record formats of the light-emitting units of the lighting modules having different structural forms, thereby achieving a conversion mapping from a complex data structure to a two-dimensional data structure. In this way, complex hierarchical relationships of the light-emitting units of the entire modular lighting fixture can be transformed into more intuitive two-dimensional data relationships in the light-emitting unit mapping table, which facilitates more efficient access and editing operations, and is conducive to the implementation of rapid conversion from a lighting effect application package to timing control data.

Based on any embodiment of the method of the present disclosure, referring to FIG. 6, converting, according to the topological ordering relationship represented by the light-emitting unit mapping table corresponding to the modular lighting fixture, the lighting effect control parameters of each of the layers into timing control data includes the following steps:

In step S5210, for each of the layers, based on the light-emitting unit mapping table, the corresponding unit instruction table is generated, such that each data record in the unit instruction table is used as the control data for a corresponding light-emitting unit.

For each layer, the light-emitting unit mapping table may be used as a template to duplicate a unit instruction table. Compared with the light-emitting unit mapping table, the unit instruction table may additionally include, as required, several extended fields for storing data extended based on region information and lighting effect information, such that each data record corresponding to each light-emitting unit, in addition to the portion of data generated based on the topological information, further includes data extended according to the lighting effect application package. By combining the two portions of data, the control data corresponding to each light-emitting unit is acquired.

In step S5220, for each of the layers, based on effective light-emitting regions specified in the region information in the lighting effect control parameters of the layer, effectiveness of the respective light-emitting units within the respective light-emitting regions in the unit instruction table of the layer is marked as corresponding extended fields in the unit instruction table.

For each layer, the region information in the lighting effect control parameters specifies the effective light-emitting regions of the respective lighting modules. Therefore, in the unit instruction table of the layer, one of the extended fields is used to mark the effectiveness of the respective light-emitting regions of the respective lighting modules. For example, if the light-emitting region to which a light-emitting unit belongs is an effective light-emitting region, the value of the extended field is set to 1. Otherwise, the value is set to 0; when the lighting module subsequently receives the control data of the corresponding light-emitting region, the corresponding light-emitting region may be interpreted as not requiring light-emitting control, such that the specific light-emitting region can be effectively prevented from light emitting.

In step S5230, for each of the layers, based on the lighting effect information in the lighting effect control parameters of the layer, light-emitting color information and light-emitting timing information of the respective light-emitting units within the respective light-emitting regions in the unit instruction table of the layer are determined as corresponding extended fields in the unit instruction table.

For each layer, regardless of how the lighting effect information in the lighting effect control parameters is defined, the controller can, through corresponding preset service logic, convert various data therein into the light-emitting color information and the light-emitting timing information corresponding to the respective light-emitting units. Accordingly, corresponding extended fields are also set in the unit instruction table to store the light-emitting color information and the light-emitting timing information of the respective light-emitting units.

The unit instruction tables of the respective layers may all be constructed according to the above process. The extended fields required by each unit instruction table may also be flexibly configured according to actual service requirements, which does not affect the inventive concept of the present disclosure.

In step S5240, the unit instruction tables of the respective layers are respectively converted into the timing control data with the light-emitting control chips in the light-emitting units as a control granularity.

In the respective unit instruction tables acquired by the controller through conversion, the respective data records already represent various data required for the corresponding light-emitting units to perform light-emitting control, and also represent, through the light-emitting regions and the lighting modules to which the light-emitting units belong, and the like, sequence positions in the electrical control structure of the modular lighting fixture. In this case, a data set composed of data of the respective fields of each data record effectively constitutes control data used for controlling whether the corresponding light-emitting unit operates. Since all data records in the unit instruction table have been ordered in advance according to the connection relationship information characterized in the topological information, it is only necessary to sequentially concatenate the control data formed by the respective data records, thereby acquiring the timing control data corresponding to the entire unit instruction table, that is, the timing control data of the corresponding layer. The timing control data naturally use the light-emitting units as a control granularity, and since the corresponding light-emitting color information and light-emitting timing information are added previously through the extended fields, the timing control data constitute complete lighting effect control data.

According to the above embodiments, it can be understood that after the controller generates a light-emitting unit mapping table, when subsequently applying the lighting effect application package, the controller may, based on the light-emitting unit mapping table, map the lighting effect control parameters provided in the lighting effect application package to the light-emitting unit mapping table with the light-emitting units as a basic granularity, thereby rapidly acquiring the unit instruction tables of the respective layers. The unit instruction tables may then be directly converted into corresponding timing control data, thereby achieving rapid conversion from lighting effect definition to instruction definition, decoupling lighting effect definition from instruction execution, improving customization and parsing/execution efficiency of the lighting effect application package, and achieving a standardized conversion mechanism for the lighting effect application package, which is conducive to industrial promotion of modular lighting fixtures.

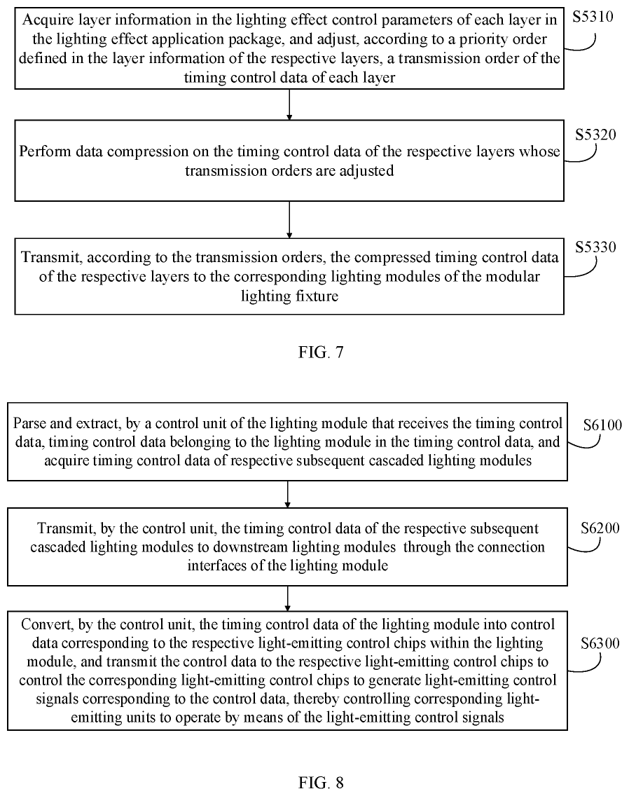

Based on any embodiment of the method of the present disclosure, referring to FIG. 7, outputting the timing control data to the respective lighting modules of the modular lighting fixture includes the following steps:

In step S5310, layer information in the lighting effect control parameters of each layer in the lighting effect application package is acquired, and according to a priority order defined in the layer information of the respective layers, the transmission order of the timing control data of each layer is adjusted.

In the case where the lighting effect application package defines the lighting effect control parameters of a plurality of layers, the layer information of each layer is generally defined in the lighting effect control parameters of the corresponding layer. As described above, the layer information mainly defines the priority order of the current layer, and according to the priority order of the current layer, the timing control data corresponding to the respective unit instruction tables may be ordered by using the service logic preset by the controller, thereby acquiring the final timing control data formed by concatenating the timing control data of all layers. In the timing control data, the transmission orders of the respective layers have been adjusted and set according to the priority orders of the respective layers.

In step S5320, data compression is performed on the timing control data of the respective layers whose transmission orders are adjusted.

For the timing control data of the respective layers whose transmission orders are adjusted, data compression may be performed separately, and various feasible manners may be flexibly used as the data compression manner. In an exemplary embodiment, considering that some light-emitting regions of the lighting modules in the unit instruction table are marked as non-effective light-emitting regions, these non-effective light-emitting regions may be directly represented as special identifiers, such as “0000”, so as to reduce the number of bytes thereof; considering that the lighting modules having the same structural form have identical light-emitting region and light-emitting unit topological structures, by utilizing this relationship, the ordering relationships of different light-emitting units may be represented by the ordering relationship in the timing control data, thereby reducing bytes used for representing the ordering identifiers of the light-emitting units. Other similar approaches may also be adopted, provided that the number of bytes of the timing control data can be reduced.

In step S5330, according to the transmission orders, the compressed timing control data of the respective layers are transmitted to the corresponding lighting modules of the modular lighting fixture.

After data compression of the timing control data corresponding to all layers is completed, the compressed timing control data may be respectively transmitted, according to the transmission orders, to the respective lighting modules of the modular lighting fixture. Each lighting module acquires the timing control data corresponding thereto from the timing control data of the respective layers sequentially received, and applies the same accordingly.

According to the above embodiments, it can be seen that in a multi-layer scenario, by only adjusting the order of the timing control data of the respective layers using the layer information in the lighting effect application package, all lighting modules can be orderly controlled to display multi-layer lighting effects in a coordinated manner. Since the timing control data of the respective layers have been acquired through rapid conversion based on the unit instruction tables and then compressed, the introduction of the layer information does not cause a significant increase in computational load, and the overall process remains relatively efficient, while enabling display of complex lighting effects. Moreover, since the compressed data has a reduced number of bytes, a large number of control chips used in the lighting modules may be low-cost embedded control chips, thereby inevitably facilitating industrial promotion of the modular lighting fixture as a whole.

Based on any embodiment of the method of the present disclosure, referring to FIG. 8, after outputting the timing control data to the respective lighting modules of the modular lighting fixture, the method includes the following steps:

In step S6100, a control unit of the lighting module that receives the timing control data parses and extracts timing control data belonging to the lighting module in the timing control data, and acquires timing control data of respective subsequent cascaded lighting modules.

For each lighting module, when the control unit thereof receives timing control data transmitted by the controller via an upstream lighting module of the lighting module, the control unit, according to service logic pre-agreed with the controller, first parses and extracts a portion of the timing control data corresponding to itself, i.e., the timing control data belonging to the lighting module, and treats the remaining portion of the timing control data as timing control data of subsequent cascaded lighting modules.

In step S6200, the control unit transmits the timing control data of the respective subsequent cascaded lighting modules to downstream lighting modules through the connection interfaces of the lighting module.

For the timing control data of the subsequent cascaded lighting modules, the control unit of the lighting module forwards and outputs the timing control data to other downstream lighting modules via the connection interfaces whose internal connection states are output states, such that the downstream lighting modules process the received timing control data according to the same service logic as that of the lighting module.

In step S6300, the control unit converts the timing control data of the lighting module into control data corresponding to the respective light-emitting control chips within the lighting module, and transmits the control data to the respective light-emitting control chips to control the corresponding light-emitting control chips to generate light-emitting control signals corresponding to the control data, thereby controlling corresponding light-emitting units to operate by means of the light-emitting control signals.

For the timing control data belonging to the lighting module, the control unit of the lighting module further converts the timing control data into control data corresponding to the respective light-emitting units in the lighting module, and transmits the control data to the light-emitting control chips of the respective light-emitting units for reception. In an embodiment, if the timing control data is in an uncompressed data format, the data may be directly transmitted to the respective light-emitting units, such that a portion of the control data corresponding to each light-emitting unit is extracted and applied. In another embodiment, if the timing control data is compressed previously, the control unit may first parse and convert the data and then transmit the data to the respective light-emitting units.

After receiving the timing control data, the light-emitting control chips of the light-emitting units can extract the control data corresponding to themselves, then generate corresponding light-emitting control signals based on the control data, and drive, by means of the light-emitting control signals, the LED packages of the light-emitting units to emit light according to the light-emitting color information and the light-emitting timing information in the control data. Each light-emitting unit is controlled to emit light according to the above mechanism, such that lighting effects can be displayed in a coordinated manner.

According to the above embodiments, it can be seen that under the action of the timing control data implemented based on the light-emitting unit mapping table in the present disclosure, the respective lighting modules are capable of parsing and executing the timing control data in a standardized manner, driving the corresponding light-emitting units to operate through the timing control data, and displaying the lighting effects defined in the lighting effect application package in a coordinated manner. It can be seen that even in the presence of a complex architecture including multiple layers, multiple lighting modules, multiple light-emitting regions, and multiple light-emitting units, the lighting effects can still be displayed effectively, thereby improving practical applicability of modular lighting fixtures and facilitating promotion thereof.

In summary, the present disclosure provides a data conversion basis for the lighting effect control parameters of the respective layers through the light-emitting unit mapping table, converts the complex lighting effect control parameters of multiple layers into timing control data, standardizes the parsing and application of lighting effects by the modular lighting fixture, reduces the difficulty in writing the lighting effect application package, improves efficiency of lighting effect parsing and displaying, enhances user experience, and is conducive to industrial promotion of modular lighting fixtures.

The method for displaying a lighting effect of the present disclosure may be divided into steps corresponding to the controller and the lighting modules, respectively, and implemented as corresponding computer program products. The computer program products are correspondingly installed and executed in the control chip of the controller of the modular lighting fixture and the control chips of the lighting modules, such that the controller controls the respective lighting modules to display corresponding lighting effects in a coordinated manner according to the lighting effect application package.

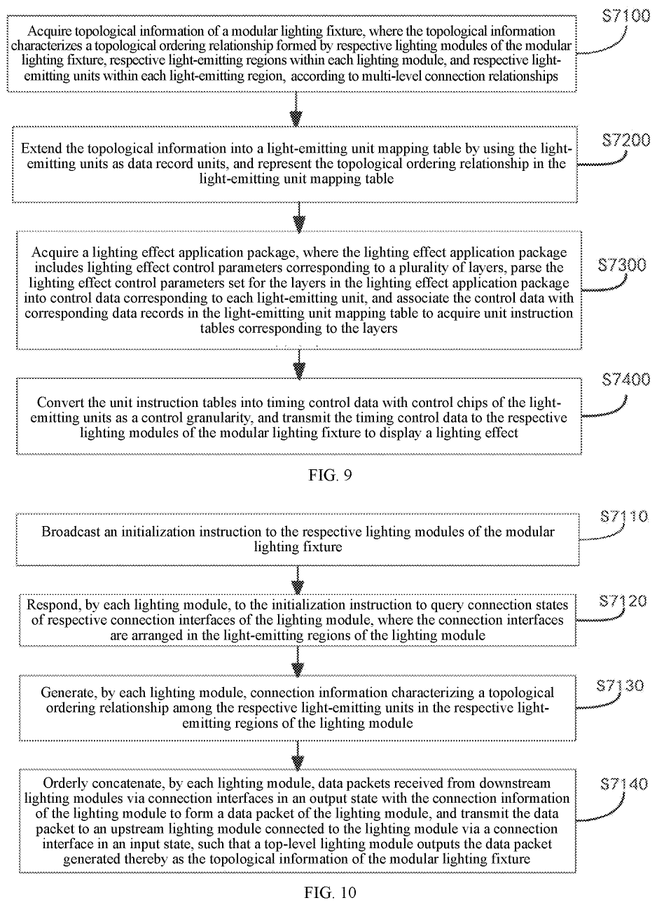

The present disclosure further provides a method for displaying a lighting effect. Referring to FIG. 9, in one embodiment, the method for displaying a lighting effect of the present disclosure includes the following steps:

In step S7100, topological information of a modular lighting fixture is acquired, where the topological information characterizes a topological ordering relationship formed by respective lighting modules of the modular lighting fixture, respective light-emitting regions within each lighting module, and respective light-emitting units within each light-emitting region, according to multi-level connection relationships.

The modular lighting fixture is typically installed on the facade of a physical space, and is formed by sequentially assembling the respective lighting modules and connecting them to the controller by a user. After the modular lighting fixture is assembled, topological information corresponding to the planar array pattern formed by the respective lighting modules of the modular lighting fixture can be acquired.

The acquisition of the topological information corresponding to the planar array pattern of the modular lighting fixture may be implemented by the controller of the current modular lighting fixture executing corresponding preset service logic. In an embodiment, after the modular lighting fixture is assembled and started for the first time, the controller of the modular lighting fixture may, by default, execute the service logic for acquiring topological information. Alternatively, the user may drive the controller to acquire the topological information among the respective lighting modules through buttons provided by a terminal device or the controller. In another embodiment, the user may first define the topological information corresponding to the planar array pattern of the entire modular lighting fixture in the terminal device, and then transmit the topological information to the controller. The topological information may be stored in the memory of the controller, so as to be directly called each time the lighting effect is displayed. That is, when acquiring topological information, the controller may also call previously acquired and stored topological information. Therefore, in the same modular lighting fixture, the controller only needs to acquire the topological information once, and the process of the present disclosure is re-executed only when the assembly relationship among the lighting modules of the modular lighting fixture changes.

In terms of content, the topological information of the modular lighting fixture mainly represents the topological ordering relationship in which the lighting modules are organized according to a multi-level connection relationship, so as to provide corresponding connection positions and connection ordering of the interconnection among the respective lighting modules, which may be regarded as ordering. The topological information further represents the light-emitting regions in which the respective light-emitting units in each lighting module are distributed, as well as corresponding ordering identifiers. Since the light-emitting regions are mainly used for performing partitioned management on the light-emitting units of the lighting module, through this topological ordering relationship, multi-level connection relationships formed among the respective lighting modules of the modular lighting fixture, the respective light-emitting regions within each lighting module, and the respective light-emitting units within each light-emitting region are represented, that is, the network topology of all the light-emitting units of all the lighting modules of the entire modular lighting fixture is described.

In some embodiments, the topological information may only include the structural forms of the lighting modules, and the controller prestores mapping relationship data corresponding to various structural forms, where the mapping relationship data define relationships between light-emitting regions and the light-emitting units arranged in the respective light-emitting regions. When the structural form of a certain lighting module is determined from the topological information, the mapping relationship data may be called and used as a basis for constructing the mapping relationship between the respective light-emitting units and the light-emitting regions in the light-emitting unit mapping table in subsequent steps of the present disclosure.

In terms of representation form, the topological information of the modular lighting fixture may be represented as a text file, a style file such as an XML file, or a message structure, and may be flexibly implemented, provided that it is suitable for correspondingly describing the tree-like multi-level structure formed by the network topology of the light-emitting units.

Specific parameters used in the modular lighting fixture to define the topological ordering relationship may be flexibly configured as required. For example, in some embodiments, the light-emitting region to which the light-emitting unit belongs may be defined as attribute data of the light-emitting unit; in some embodiments, each light-emitting region may be defined as an independent object, and the corresponding light-emitting units are represented as attribute data of the light-emitting region. Such cases do not affect the inventive concept of the present disclosure and are not exhaustively listed herein.

In step S7200, the topological information is extended into a light-emitting unit mapping table by using the light-emitting units as data record units, and the topological ordering relationship is represented in the light-emitting unit mapping table.

According to the present disclosure, when the modular lighting fixture is controlled to display lighting effects, at the same time point, it is necessary to specifically provide each light-emitting unit in each lighting module with corresponding control data for controlling how the light-emitting unit emits light. That is, in the present disclosure, the control of lighting effects is specifically performed at a control granularity using the light-emitting unit as a basic unit. However, the topological information of the modular lighting fixture itself is represented by multi-level connection relationships, which leads to a problem of how to implement efficient data conversion. Therefore, in the present disclosure, a light-emitting unit mapping table is created by the controller for lighting effect conversion of the modular lighting fixture. The light-emitting unit mapping table is used for implementing a two-dimensional conversion representation of the topological ordering relationship of concatenated information of the modular lighting fixture, so as to store the topological ordering information corresponding to the respective light-emitting units.

In the light-emitting unit mapping table, one corresponding data record is configured for each light-emitting unit in the modular lighting fixture. In an exemplary embodiment, fields such as an identity identifier and an ordering identifier of the light-emitting unit, the light-emitting region to which the light-emitting unit belongs, the lighting module to which the light-emitting unit belongs, and the ordering position of the lighting module to which the light-emitting unit belongs in the branch chain are represented in the form of attribute data in the data record. Furthermore, in other embodiments, other fields such as the ordering identifier of the light-emitting region may also be added, which may be flexibly configured as required. In summary, it can be readily understood from this example that the light-emitting unit mapping table converts complex multi-level connection relationships of the modular lighting fixture represented in topological information into more intuitive two-dimensional data records. Each data record corresponds to one light-emitting unit within one lighting module of the modular lighting fixture, thereby achieving data representation with the control chips of the light-emitting units as a control granularity and facilitating subsequent further data conversion.

In an embodiment, the respective data records in the light-emitting unit mapping table may, as required, be ordered in multiple fields according to a data communication order from the controller to the respective lighting modules, the respective regions, and the respective light-emitting units, such that all light-emitting units can be arranged in accordance with a serial signal order in the modular lighting fixture. In this way, control data corresponding to the respective light-emitting units can be directly assembled according to such an ordering relationship to generate timing control data to be transmitted to the respective lighting modules, thereby achieving higher conversion efficiency.

Once established, the light-emitting unit mapping table can be reused subsequently. Thus, the controller may store the light-emitting unit mapping table in its memory for subsequent use. When the assembly relationship among the lighting modules in the modular lighting fixture changes, steps S7100 and S7200 may be re-executed to regenerate a new light-emitting unit mapping table; otherwise, if only a new lighting effect application package is applied, steps S7100 and S7200 do not need to be re-executed, and steps S7300 and S7400 are executed each time a new lighting effect application package is applied.

In step S7300, the lighting effect control parameters set for the layers in the lighting effect application package are parsed into the control data corresponding to each light-emitting unit, and the control data are associated with the corresponding data records in the light-emitting unit mapping table to acquire the unit instruction tables corresponding to the layers.

The lighting effect application package that is required to be converted into the timing control data of the respective lighting modules is mainly used for defining the lighting effect control parameters corresponding to one or more layers of a lighting effect, and the lighting effect displayed by the modular lighting fixture is described through the lighting effect control parameters.

The lighting effect application package may be transmitted from a terminal device to the controller and stored by the controller in a local memory. Alternatively, a lighting effect application package already stored in the memory may be directly called. The lighting effect application package may first be acquired and then parsed to obtain various lighting effect control parameters defined therein that correspond to the lighting effect. For example, the lighting effect control parameters include layer information for specifying corresponding layers, region information for specifying light-emitting regions of the lighting modules, and lighting effect information for specifying light-emitting units within corresponding light-emitting regions to emit light according to specific parameters. In an embodiment, the region information of the lighting effect application package generally only needs to define the light-emitting regions corresponding to each lighting module, and generally does not need to specify light-emitting units. In the controller, by means of the mapping relationship between the light-emitting regions and the light-emitting units in the preconfigured light-emitting unit mapping table, the light-emitting units of the respective lighting modules corresponding to the effective light-emitting regions specified by each piece of region information can be rapidly determined.

The various lighting effect control parameters of each layer described above may be converted into control data corresponding to each light-emitting unit within each lighting module in the modular lighting fixture, and associated with corresponding data records in the light-emitting unit mapping table, such that, for each layer, a corresponding unit instruction table is acquired.

For example, the layer information in the lighting effect control parameters mainly indicates a relative displaying relationship among the respective layers, such as sequential display of the respective layers or synchronous display of some layers. Correspondingly, in the time domain, the layer information of the current layer defines the display timing and/or display duration of the layer. Therefore, the layer information further defines, for the current layer, the display timing and/or display duration of the respective light-emitting units of the modular lighting fixture. Accordingly, corresponding light-emitting timing information of the respective light-emitting units in the light-emitting unit mapping table can be configured based on the layer information.

The region information in the lighting effect control parameters mainly indicates, in the current layer, which one or more light-emitting regions of each lighting module are responsible for emitting light or not emitting light, which is generally determined by specifying effective light-emitting regions of the lighting module. Accordingly, for whether the light-emitting regions corresponding to the respective light-emitting units in the light-emitting unit mapping table belong to the effective light-emitting regions, the respective light-emitting units can be correspondingly marked, so as to indicate whether the corresponding light-emitting unit works or does not work, or to indicate whether the corresponding light-emitting unit emits light in a default manner or emits light based on specified lighting effect information.

The lighting effect information in the lighting effect control parameters mainly indicates, in the current layer, how the respective effective light-emitting regions of the respective lighting modules within the entire planar array pattern range of the modular lighting fixture emit light in a coordinated manner to present corresponding motion effects, that is, the lighting effect information indicates a lighting effect motion process corresponding to the current layer. Therefore, the lighting effect information generally includes motion parameters, light-emitting color parameters, light-emitting duration, and the like, which may be provided as required. These parameters specifically affect light-emitting control of the LED packages of each light-emitting unit. Therefore, it is necessary to determine, based on the lighting effect information and in accordance with preset calculation service logic, various specific parameters corresponding to each light-emitting unit, such as light-emitting timing information, light-emitting color information, and even light-emitting duration information, and to respectively associate these specific parameters with the corresponding light-emitting units in the light-emitting unit mapping table. For time-related parameters of the light-emitting units, such as the light-emitting timing information and the light-emitting duration information, since such parameters may be constrained by display timing and/or display duration corresponding to the layer to which the light-emitting units belong, such parameters may be determined in coordination with the display timing and/or display duration of the layer.

It can be seen that after the lighting effect control parameters of each layer are correspondingly converted and associated with the corresponding light-emitting units in the light-emitting unit mapping table according to the above principles, the light-emitting unit mapping table is thus extended to obtain a unit instruction table corresponding to each layer. Each unit instruction table includes distribution information of the light-emitting units in a hardware structure, timing information of the light-emitting units in an electrical control structure, corresponding attribute information indicating the light emission of the light-emitting units, and the like. All data related to the operation of each light-emitting unit are extended into one-dimensional data in the data records, and all lighting effect control parameters corresponding to the entire layer are also extended into two-dimensional data represented by the data records corresponding to the respective light-emitting units in the unit instruction table. It can be seen that this representation is significantly convenient, intuitive and efficient, and more convenient for corresponding conversion, which can improve the conversion efficiency of converting the lighting effect control parameters in the lighting effect application package into corresponding timing control data.

In step S7400, the unit instruction tables are converted into timing control data with control chips of the light-emitting units as a control granularity, and the timing control data are transmitted to the respective lighting modules of the modular lighting fixture to display a lighting effect.

After processing through the above process, it can be readily understood that each layer in the lighting effect application package can acquire a corresponding unit instruction table. In the unit instruction table, control data required by each light-emitting unit in the entire modular lighting fixture to perform light emission control are represented by respective data records, and the data of the respective fields in each data record can be configured as the control data. Accordingly, the control data of each light-emitting unit is used as a basic unit, and the timing control data corresponding to the current layer can be acquired by orderly concatenating the control data of each light-emitting unit based on the light-emitting timing information corresponding to the respective lighting modules, the light-emitting regions corresponding to each lighting module, and the respective light-emitting units within each light-emitting region. From the perspective of the light-emitting units, the timing control data is represented as a one-dimensional serialized data structure, in which the light-emitting unit serves as a basic control granularity. Therefore, when the timing control data are transmitted to the respective lighting modules in the branch chain, each lighting module may sequentially extract the timing control data corresponding to itself to implement the light emission control of the lighting module. When the lighting module transmits the extracted timing control data corresponding to itself to the respective light-emitting units, each light-emitting unit may also extract the control data corresponding to itself to implement the light emission control on its own LED packages. Through this mechanism, the corresponding light-emitting units in the entire modular lighting fixture are capable of controlling the corresponding LED packages to emit light in a coordinated manner under the action of their own corresponding control data, thereby presenting corresponding lighting effects.

In an embodiment, for the unit instruction tables corresponding to the plurality of layers, the controller may sequentially convert the timing control data corresponding to the respective layers according to the order of the layers and transmit the timing control data to the corresponding lighting modules. In another embodiment, all unit instruction tables corresponding to the plurality of layers may also be converted at one time and transmitted to the corresponding lighting modules in a unified manner, provided that the control units of the respective lighting modules implement corresponding parsing and execute corresponding service logic in advance.

In some embodiments, data compression may be performed on each piece of timing control data. For example, the control data of the respective light-emitting units belonging to the same lighting module are clustered and concatenated based on the light-emitting regions or the lighting modules, such that the control data of different light-emitting units share the same data, which can subsequently be correspondingly parsed by the respective lighting modules. Therefore, the number of bytes of all timing control data can be compressed, and the control chips used by the control units of the respective lighting modules, the control chips used by the respective light-emitting units, and the like may be implemented by using lower-cost embedded chips, thereby effectively reducing the manufacturing cost of each lighting module and the entire modular lighting fixture. Considering the fact that each lighting module includes a large number of control chips, this clearly provides a significant cost advantage in large-scale production scenarios.

For one lighting effect application package, the controller of the modular lighting fixture only needs, upon the first application, to generate the unit instruction tables and the corresponding timing control data of the respective layers corresponding to the lighting effect application package by performing steps S7300 and S7400, and then can store the unit instruction tables and the corresponding timing control data of the respective layers for subsequent use. Thereafter, each time the system is powered on and a default call is required, or when a user instructs the controller to configure lighting effects corresponding to the lighting effect application package, the unit instruction tables and/or the timing control data are called from the memory, so as to acquire final timing control data that are required to be transmitted to the respective lighting modules. It is unnecessary to repeatedly perform steps S7300 and S7400 to generate the final timing control data, thereby avoiding unnecessary re-computation.

According to the above embodiments, it can be seen that the present disclosure has various technical advantages, including but not limited to:

First, according to the present disclosure, the topological information representing the topological ordering relationship among the respective lighting modules, the respective light-emitting regions, and the respective light-emitting units of the modular lighting fixture is first acquired. When a lighting effect application package is required to be parsed and used, the topological information is first subjected to two-dimensional conversion to acquire a light-emitting unit mapping table. In the light-emitting unit mapping table, various light-emitting control information of the respective light-emitting units is converted into independent data records, such that other lighting effect control parameters of the light-emitting units, including light-emitting timing information, light-emitting color information, and the like, can be conveniently configured in units of data records. Accordingly, other lighting effect application parameters in the lighting effect application package are associated with the respective light-emitting units, such that the control data of the respective light-emitting units of the respective lighting modules in the respective layers are independently and completely established to acquire unit instruction tables. In the unit instruction tables, the relationships among the respective light-emitting units arranged in an orderly manner are acquired. Finally, according to such relationships, the unit instruction tables are further subjected to dimension reduction to acquire the timing control data corresponding to the entire modular lighting fixture. The timing control data represent, with the control chips of the light-emitting units as a control granularity, various control data of the respective light-emitting units when executing lighting effects. The timing control data have a small data volume and can be transmitted efficiently. Moreover, since the timing control data correspond one-to-one with the light-emitting units of the lighting modules in a physical product, accurate display of lighting effects can be ensured, thereby improving product reliability of the modular lighting fixture.

Second, on the basis that the present disclosure can achieve efficient conversion from a lighting effect application package to time-based control instructions, on a terminal device side for customized lighting effects, various lighting effects can be edited according to natural-language logic, thereby providing a favorable user experience; and on a modular lighting fixture side, since an efficient conversion and parsing mechanism is provided, user-customized lighting effects can be rapidly understood and applied, improving lighting effect execution efficiency and undoubtedly enriching playability of the product.

In addition, modular lighting fixtures are currently in a stage of industrial promotion and development. The higher the convenience of lighting effect application, the more beneficial it is to industrial promotion of modular lighting fixtures, and the more optimistic the economic expectation will be. By providing a lighting effect conversion mechanism to improve convenience and reliability of lighting effect customization, the present disclosure improves the functions of modular lighting fixture products, and thus larger-scale economic benefits can naturally be optimistically expected.

Based on any embodiment of the method of the present disclosure, referring to FIG. 10, acquiring the topological information of the modular lighting fixture includes the following steps:

In step S7110, an initialization instruction is broadcast to the respective lighting modules of the modular lighting fixture.

To acquire the topological information of the respective lighting modules of the modular lighting fixture, the controller may broadcast an initialization instruction to the respective lighting modules, and the respective lighting modules are driven by the initialization instruction to perform self-detection, such that the respective lighting modules return their connection information to the controller.

In step S7120, each lighting module responds to the initialization instruction to query connection states of respective connection interfaces of the lighting module, where the connection interfaces are arranged in the light-emitting regions of the lighting module.

For any one lighting module that has been electrically connected to the controller, after the control chip that performs a unified control function thereof receives the initialization instruction transmitted by the controller, the lighting module, in response to the instruction, detects, via an I/O port of the control chip, connection states of connection interfaces corresponding to the respective structural edges of the lighting module. The connection states mainly include an input state, an output state, and a power-off state. The input state indicates that the lighting module is a downstream lighting module of another lighting module in the branch chain; the output state indicates that the lighting module is an upstream lighting module of another lighting module in the branch chain; and the power-off state indicates that the connection interface of the corresponding structural edge is not connected. It should be noted that the structural edge illustrated herein is essentially an independently controllable light-emitting region.

In step S7130, each lighting module generates connection information characterizing a topological ordering relationship among the respective light-emitting units in the respective light-emitting regions of the lighting module.

Through the above detection process, the control chip of each lighting module acquires the connection states of the respective connection interfaces of the lighting module, thereby identifying the connected edges and the unconnected edges in the respective structural edges of the lighting module. To satisfy the requirement for returning the connection states, in an embodiment, the connection information may be generated only based on the connection states of the connected edges. In other alternative embodiments, data corresponding to the connection states of both the connected edges and the unconnected edges may also be used to generate the connection information of the lighting module. In any case, the controller is capable of correspondingly identifying such information.

It should be noted that, since the connected edges correspond to the light-emitting regions, the connection information of the lighting module also defines the connection relationship among the light-emitting regions through the connected edges. Therefore, the connection information of the lighting module in fact also provides the electrical structure information of the lighting module itself, that is, connection relationship information among the respective light-emitting units in the respective light-emitting regions within the lighting module.

In step S7140, each lighting module orderly concatenates data packets received from downstream lighting modules via connection interfaces in an output state with the connection information of the lighting module to form a data packet of the lighting module, and transmits the data packet to an upstream lighting module connected to the lighting module via a connection interface in an input state, such that a top-level lighting module outputs the data packet generated thereby as the topological information of the modular lighting fixture.

To ensure that the respective lighting modules in each branch chain effectively return their respective connection information to the controller according to the standardized data communication protocol, each lighting module may upload its connection information along the branch chain according to a uniformly defined service logic. Specifically, for the lighting module, the connection information of its downstream lighting modules is encapsulated into the data packets and uploaded along the branch chain to the lighting module. After the lighting module generates its own connection information and acquires the entire data packet uploaded from the downstream lighting modules, the lighting module thereby acquires the connection information of itself and of its respective downstream lighting modules. To indicate the hierarchical order of the lighting module in the branch chain, the control chip of the lighting module orderly combines its own connection information with the data packets of the respective downstream lighting modules in a predetermined sequence, thereby forming a new data packet. Such combination is performed in accordance with a preset protocol format, so as to effectively indicate the hierarchical order of the lighting module in the new data packet. Thereafter, the lighting module uploads the new data packet further upward along the branch chain to an upstream lighting module. Each lighting module operates according to the aforementioned service logic. By analogy, the top-level lighting module is the first lighting module directly connected to the controller, and the first lighting module transmits the final data packet generated thereby to the controller, such that the controller acquires the connection information of all lighting modules in the branch chain. Since the data packet submitted to the controller by the top-level lighting module already represents, through a specific data structure, a multi-level connection ordering relationship among the respective lighting modules, the respective light-emitting regions, and the respective light-emitting units in the branch chain, the data packet may be regarded as the topological information of the present disclosure.

After the controller acquires the topological information returned by all lighting modules, the controller correspondingly determines the hierarchical orders of the respective lighting modules by adapting to the manner in which the hierarchical orders are indicated when the respective lighting modules return their connection information, thereby obtaining hierarchical ordering relationship information of the respective branch chains, the respective lighting modules and their light-emitting regions in each branch chain, as well as the respective light-emitting units and other objects in the entire modular lighting fixture.

It can be readily understood that, when a plurality of branch chains exist in the modular lighting fixture, the topological information of each branch chain can be acquired in the same manner, and the controller only needs to distinguish different branch chains and apply the corresponding topological information thereto.

According to the above embodiments, it can be seen that, by implementing standardized service logic in each lighting module, standardized production of the lighting modules can be achieved. By means of the effect produced by the service logic during runtime, the user may indiscriminately use arbitrary lighting modules for assembly, thereby assembling a desired planar array pattern. Regardless of the shape of the planar array pattern, each lighting module in the modular lighting fixture can accurately perceive, characterize, and transmit its own control structure information and its hierarchical order in the branch chain, as well as other multi-level connection relationship information, such that the modular lighting fixture can implement lighting effect conversion and application based on such connection relationship information.

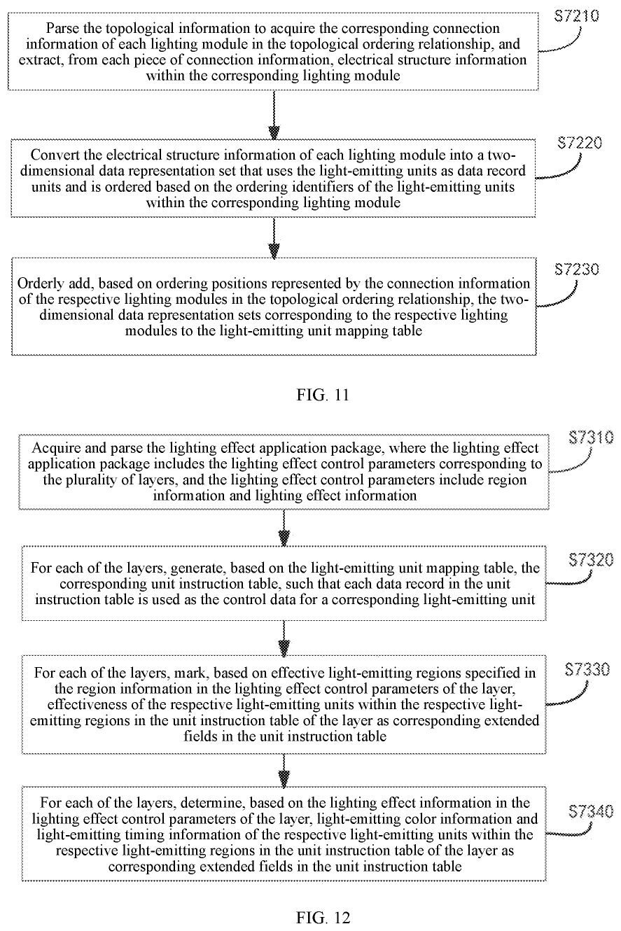

Based on any embodiment of the method of the present disclosure, referring to FIG. 11, extending the topological information into the light-emitting unit mapping table by using the light-emitting units as the data record units includes the following steps:

In step S7210, the topological information is parsed to acquire the corresponding connection information of each lighting module in the topological ordering relationship, and electrical structure information within the corresponding lighting module is extracted from each piece of connection information, where the electrical structure information includes identity identifiers and ordering identifiers of the respective light-emitting units in the lighting module, and region identifiers of the light-emitting regions to which the light-emitting units belong.

After the controller acquires the topological information of the modular lighting fixture, the controller may parse the topological information accordingly, thereby extracting the connection information corresponding to each lighting module. The connection information of each lighting module already represents the electrical structure information corresponding to the connection relationship among the respective light-emitting units covered by the respective light-emitting regions within the lighting module. In one embodiment, the electrical structure information includes the identity identifiers and the ordering identifiers of the respective light-emitting units in the lighting module, and the region identifiers of the light-emitting regions to which the light-emitting units belong. Therefore, the topological ordering relationship among the respective light-emitting regions and the respective light-emitting units within the lighting module can be acquired based on the electrical structure information of the lighting module.

In step S7220, the electrical structure information of each lighting module is converted into a two-dimensional data representation set that uses the light-emitting units as data record units and is ordered based on the ordering identifiers of the light-emitting units within the corresponding lighting module.

The modular lighting fixture is formed by assembling a plurality of lighting modules, and the respective lighting modules may differ in shape, and their electrical structure information may also differ from one another. Therefore, for each lighting module, a two-dimensional data representation set corresponding to the lighting module required for constructing a light-emitting unit mapping table may be constructed based on the electrical structure information of the lighting module. In the two-dimensional data representation set, the respective light-emitting units may be ordered according to their ordering identifiers.

Specifically, for each lighting module, the respective items of information in the electrical structure information of the lighting module, including, for example, the identity identifiers and the ordering identifiers of the respective light-emitting units, and the region identifiers of the light-emitting regions to which the light-emitting units belong, are extended into data records corresponding to the respective light-emitting units. In addition, each data record may further be extended with a field indicating the lighting module identifier of the lighting module to which the light-emitting units belong, thereby acquiring a corresponding data record for each light-emitting unit in the lighting module. All data records corresponding to all light-emitting units of the lighting module together constitute the two-dimensional data representation set of the lighting module.

In step S7230, based on ordering positions represented by the connection information of the respective lighting modules in the topological ordering relationship, the two-dimensional data representation sets corresponding to the respective lighting modules are orderly added to the light-emitting unit mapping table.

After the respective lighting modules acquire their corresponding two-dimensional data representation sets, the two-dimensional data representation sets of the respective lighting modules may be orderly added into a blank light-emitting unit mapping table according to an ordering relationship, i.e., the ordering positions of the respective lighting modules in the topological ordering relationship represented by the topological information, as indicated by the respective connection information of the lighting modules, that is, the hierarchical orders of the lighting modules in the entire branch chain, or the arrival order when the controller transmits instructions or data downstream along the branch chain. Therefore, the light-emitting unit mapping table includes the data records corresponding to all light-emitting units of all lighting modules, and the data records are arranged in an ordered manner, thereby facilitating subsequent sequential concatenation to acquire timing control data.

According to the above embodiments, it can be readily understood that the controller of the modular lighting fixture, by parsing and applying the topological information, is capable of converting topological information represented in any format into a standardized light-emitting unit mapping table, and further capable of unifying data record formats of the light-emitting units of the lighting modules having different structural forms, thereby achieving a conversion mapping from a complex data structure to a two-dimensional data structure. In this way, complex hierarchical relationships of the light-emitting units of the entire modular lighting fixture can be transformed into more intuitive two-dimensional data relationships in the light-emitting unit mapping table, which facilitates more efficient access and editing operations, and is conducive to the implementation of rapid conversion from a lighting effect application package to timing control data.

Based on any embodiment of the method of the present disclosure, referring to FIG. 12, parsing the lighting effect control parameters set for the layers in the lighting effect application package into the control data corresponding to each light-emitting unit, and associating the control data with the corresponding data records in the light-emitting unit mapping table to acquire the unit instruction tables corresponding to the layers include the following steps:

In step S7310, the lighting effect application package is acquired and parsed, where the lighting effect application package includes the lighting effect control parameters corresponding to the plurality of layers, and the lighting effect control parameters include region information and lighting effect information.

As described above, the lighting effect application package may be acquired by the controller from an external terminal device or directly called from the memory, and the lighting effect application package includes the lighting effect control parameters corresponding to a plurality of layers. For each layer, the region information and lighting effect information included in the lighting effect control parameters can be used to construct a corresponding unit instruction table, and the control data of the respective light-emitting units of the modular lighting fixture are improved in the unit instruction table.

In step S7320, for each of the layers, based on the light-emitting unit mapping table, the corresponding unit instruction table is generated, such that each data record in the unit instruction table is used as the control data for a corresponding light-emitting unit.

For each layer, the light-emitting unit mapping table may be used as a template to duplicate a unit instruction table. Compared with the light-emitting unit mapping table, the unit instruction table may additionally include, as required, several extended fields for storing data extended based on region information and lighting effect information, such that each data record corresponding to each light-emitting unit, in addition to the portion of data generated based on the topological information, further includes data extended according to the lighting effect application package. By combining the two portions of data, the control data corresponding to each light-emitting unit is acquired.

In step S7330, for each of the layers, based on effective light-emitting regions specified in the region information in the lighting effect control parameters of the layer, effectiveness of the respective light-emitting units within the respective light-emitting regions in the unit instruction table of the layer is marked as corresponding extended fields in the unit instruction table.

For each layer, the region information in the lighting effect control parameters specifies the effective light-emitting regions of the respective lighting modules. Therefore, in the unit instruction table of the layer, one of the extended fields is used to mark the effectiveness of the respective light-emitting regions of the respective lighting modules. For example, if the light-emitting region to which a light-emitting unit belongs is an effective light-emitting region, the value of the extended field is set to 1. Otherwise, the value is set to 0; when the lighting module subsequently receives the control data of the corresponding light-emitting region, the corresponding light-emitting region may be interpreted as not requiring light-emitting control, such that the specific light-emitting region can be effectively prevented from light emitting.

In step S7340, for each of the layers, based on the lighting effect information in the lighting effect control parameters of the layer, light-emitting color information and light-emitting timing information of the respective light-emitting units within the respective light-emitting regions in the unit instruction table of the layer are determined as corresponding extended fields in the unit instruction table.

For each layer, regardless of how the lighting effect information in the lighting effect control parameters is defined, the controller can, through corresponding preset service logic, convert various data therein into the light-emitting color information and the light-emitting timing information corresponding to the respective light-emitting units. Accordingly, corresponding extended fields are also set in the unit instruction table to store the light-emitting color information and the light-emitting timing information of the respective light-emitting units.

The unit instruction tables of the respective layers may all be constructed according to the above process. The extended fields required by each unit instruction table may also be flexibly configured according to actual service requirements, which does not affect the inventive concept of the present disclosure.

According to the above embodiments, it can be understood that after the controller generates a light-emitting unit mapping table, when subsequently applying the lighting effect application package, the controller may, based on the light-emitting unit mapping table, map the lighting effect control parameters provided in the lighting effect application package to the light-emitting unit mapping table with the light-emitting units as a basic granularity, thereby rapidly acquiring the unit instruction tables of the respective layers, achieving rapid conversion from lighting effect definition to instruction definition, decoupling lighting effect definition from instruction execution, improving customization and parsing/execution efficiency of the lighting effect application package, and achieving a standardized conversion mechanism for the lighting effect application package, which is conducive to industrial promotion of modular lighting fixtures.

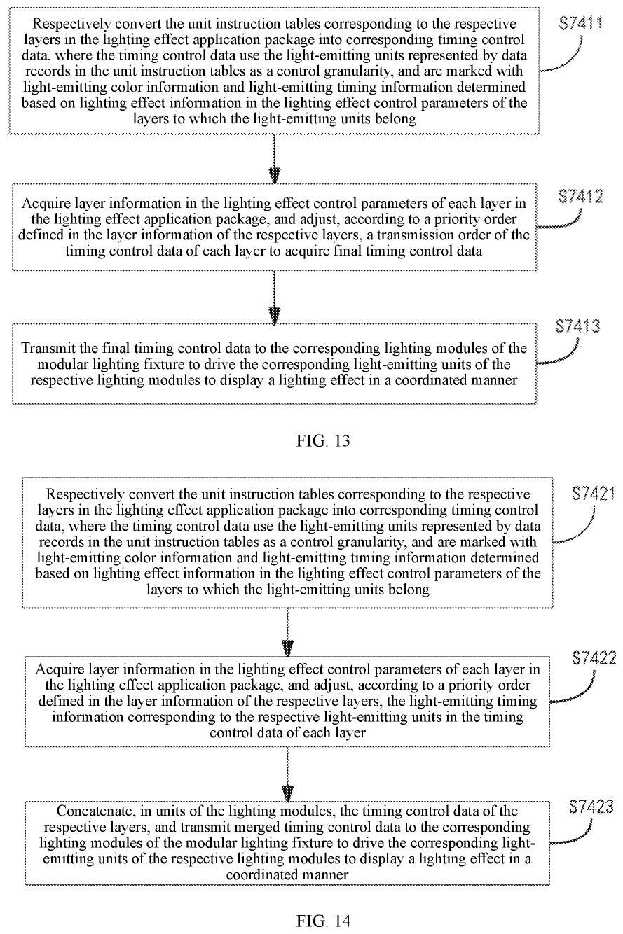

Based on any embodiment of the method of the present disclosure, referring to FIG. 13, converting the unit instruction tables into timing control data with control chips of the light-emitting units as a control granularity, and transmitting the timing control data to the respective lighting modules of the modular lighting fixture to display a lighting effect include the following steps:

In step S7411, the unit instruction tables corresponding to the respective layers in the lighting effect application package are respectively converted into corresponding timing control data, where the timing control data use the light-emitting units represented by data records in the unit instruction tables as a control granularity, and are marked with light-emitting color information and light-emitting timing information determined based on lighting effect information in the lighting effect control parameters of the layers to which the light-emitting units belong.

In the respective unit instruction tables acquired by the controller through conversion, the respective data records already represent various data required for the corresponding light-emitting units to perform light-emitting control, and also represent, through the light-emitting regions and the lighting modules to which the light-emitting units belong, and the like, sequence positions in the electrical control structure of the modular lighting fixture. In this case, a data set composed of data of the respective fields of each data record effectively constitutes control data used for controlling whether the corresponding light-emitting unit operates. Since all data records in the unit instruction table have been ordered in advance according to the connection relationship information characterized in the topological information, it is only necessary to sequentially concatenate the control data formed by the respective data records, thereby acquiring the timing control data corresponding to the entire unit instruction table, that is, the timing control data of the corresponding layer. The timing control data naturally use the control chips of the light-emitting units as a control granularity, and since the corresponding light-emitting color information and light-emitting timing information are added previously through the extended fields, the timing control data constitute complete lighting effect control data.

In step S7412, layer information in the lighting effect control parameters of each layer in the lighting effect application package is acquired, and according to a priority order defined in the layer information of the respective layers, a transmission order of the timing control data of each layer is adjusted to acquire final timing control data.

In the case where the lighting effect application package defines the lighting effect control parameters of a plurality of layers, the layer information of each layer is generally defined in the lighting effect control parameters of the corresponding layer. As described above, the layer information mainly defines the priority order of the current layer, and according to the priority order of the current layer, the timing control data corresponding to the respective unit instruction tables may be ordered by using the service logic preset by the controller, thereby acquiring the final timing control data formed by concatenating the timing control data of all layers. In the timing control data, the transmission orders of the respective layers have been correspondingly adjusted and set according to the priority orders of the respective layers.

In step S7413, the final timing control data are transmitted to the corresponding lighting modules of the modular lighting fixture to drive the corresponding light-emitting units of the respective lighting modules to display a lighting effect in a coordinated manner.

The final timing control data determined by the above process may be orderly transmitted to the respective lighting modules of the modular lighting fixture. Each lighting module acquires the timing control data of each layer, and correspondingly extracts the timing control data corresponding to the lighting module itself, such that the extracted timing control data can be used to control the respective light-emitting units of the respective light-emitting regions of the lighting module to operate or not to operate. Through the coordinated light emission control of all light-emitting units of a plurality of layers and a plurality of lighting modules, the lighting effect customized by the lighting effect application package is presented.

According to the above embodiments, it can be seen that in a multi-layer scenario, by only adjusting the order of the timing control data of the respective layers using the layer information in the lighting effect application package, all lighting modules can be orderly controlled to display multi-layer lighting effects in a coordinated manner. Since the timing control data of the respective layers have been acquired through rapid conversion based on the unit instruction tables, the introduction of the layer information does not cause a significant increase in computational load, and the overall process remains relatively efficient, while enabling display of complex lighting effects, thereby facilitating industrial promotion of modular lighting fixtures.

Based on any embodiment of the method of the present disclosure, referring to FIG. 14, converting the unit instruction tables into timing control data with control chips of the light-emitting units as a control granularity, and transmitting the timing control data to the respective lighting modules of the modular lighting fixture to display a lighting effect include the following steps:

In step S7421, the unit instruction tables corresponding to the respective layers in the lighting effect application package are respectively converted into corresponding timing control data, where the timing control data use the light-emitting units represented by data records in the unit instruction tables as a control granularity, and are marked with light-emitting color information and light-emitting timing information determined based on lighting effect information in the lighting effect control parameters of the layers to which the light-emitting units belong.

In the respective unit instruction tables acquired by the controller through conversion, the respective data records already represent various data required for the corresponding light-emitting units to perform light-emitting control, and also represent, through the light-emitting regions and the lighting modules to which the light-emitting units belong, and the like, sequence positions in the electrical control structure of the modular lighting fixture. In this case, a data set composed of data of the respective fields of each data record effectively constitutes control data used for controlling whether the corresponding light-emitting unit operates. Since all data records in the unit instruction table have been ordered in advance according to the connection relationship information characterized in the topological information, it is only necessary to sequentially concatenate the control data formed by the respective data records, thereby acquiring the timing control data corresponding to the entire unit instruction table, that is, the timing control data of the corresponding layer. The timing control data naturally use the control chips of the light-emitting units as a control granularity, and since the corresponding light-emitting color information and light-emitting timing information are added previously through the extended fields, the timing control data constitute complete lighting effect control data.

In step S7422, layer information in the lighting effect control parameters of each layer in the lighting effect application package is acquired, and according to a priority order defined in the layer information of the respective layers, the light-emitting timing information corresponding to the respective light-emitting units in the timing control data of each layer is adjusted.

In the case where the lighting effect application package defines the lighting effect control parameters of a plurality of layers, the layer information of each layer is generally defined in the lighting effect control parameters of the corresponding layer. As described above, the layer information mainly defines the priority order of the current layer, and according to the priority order of the current layer, relative time information corresponding to each layer is calculated by using the service logic preset by the controller. Then, based on the relative time information, the light-emitting timing information of each light-emitting unit in the timing control data corresponding to each unit instruction table may be reset. For example, when the first layer is displayed at the first point and the second layer is displayed at the second point, a time difference is formed between the first layer and the second layer, and based on the time difference, the light-emitting timing information of the respective light-emitting units in the timing control data corresponding to the first layer and the second layer may be modified, such that the light-emitting timing information of the respective light-emitting units in the two sets of timing control data satisfies a constraint imposed by the time difference, thereby achieving correction of the light-emitting timing information of the light-emitting units in the timing control data based on the layer information.

In step S7423, in units of the lighting modules, the timing control data of the respective layers are concatenated, and merged timing control data are transmitted to the corresponding lighting modules of the modular lighting fixture to drive the corresponding light-emitting units of the respective lighting modules to display a lighting effect in a coordinated manner.

In the timing control data of the respective layers, timing control data corresponding to each lighting module are included. Accordingly, in units of the lighting modules, all timing control data belonging to the same lighting module in the timing control data of the respective layers may be concatenated together, thereby achieving merging of the timing control data of the respective layers. The merged timing control data are transmitted to the respective lighting modules, and each lighting module correspondingly extracts timing control data belonging to itself. Thereafter, each lighting module transmits its own timing control data to the respective internal light-emitting units, so as to control the corresponding LED packages to perform light emission. Since the timing control data already define corresponding light-emitting timing information with the control chips of the light-emitting units as a control granularity, controlling the respective light-emitting units in this manner can also effectively control all light-emitting units to display lighting effects in a coordinated manner.

In the above embodiments, according to the priority order of the layer information of the respective layers, the relative time information among the respective layers is directly determined, and the light-emitting timing information of all light-emitting units of all layers is corrected based on the relative time information. Moreover, the timing control data of all layers are merged and transmitted in units of the lighting modules, facilitating centralized acquisition of timing control data for each lighting effect and avoiding multiple times of data transmissions, thereby achieving higher transmission efficiency.

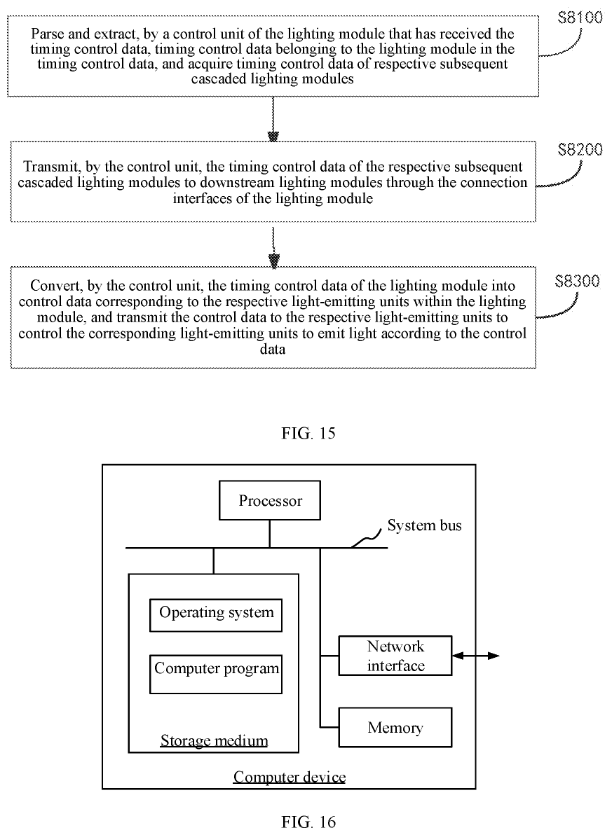

Based on any embodiment of the method of the present disclosure, referring to FIG. 15, after driving the corresponding light-emitting units of the respective lighting modules to display a lighting effect in a coordinated manner, the method includes:

In step S8100, a control unit of the lighting module that has received the timing control data parses and extracts timing control data belonging to the lighting module in the timing control data, and acquires timing control data of respective subsequent cascaded lighting modules.

For each lighting module, when the control unit thereof receives timing control data transmitted by the controller via an upstream lighting module of the lighting module, the control unit, according to service logic pre-agreed with the controller, first parses and extracts a portion of the timing control data corresponding to itself, i.e., the timing control data belonging to the lighting module, and treats the remaining portion of the timing control data as timing control data of subsequent cascaded lighting modules.

In step S8200, the control unit transmits the timing control data of the respective subsequent cascaded lighting modules to downstream lighting modules through the connection interfaces of the lighting module.

For the timing control data of the subsequent cascaded lighting modules, the control unit of the lighting module forwards and outputs the timing control data to other downstream lighting modules via the connection interfaces whose internal connection states are output states, such that the downstream lighting modules process the received timing control data according to the same service logic as that of the lighting module.

In step S8300, the control unit converts the timing control data of the lighting module into control data corresponding to the respective light-emitting units within the lighting module, and transmits the control data to the respective light-emitting units to control the corresponding light-emitting units to emit light according to the control data.

For the timing control data belonging to the lighting module, the control unit of the lighting module further converts the timing control data into control data corresponding to the respective light-emitting units in the lighting module. In an embodiment, if the timing control data is in an uncompressed data format, the data may be directly transmitted to the respective light-emitting units, such that a portion of the control data corresponding to each light-emitting unit is extracted and applied. In another embodiment, if the timing control data is compressed previously, the control unit may first parse and convert the data and then transmit the data to the respective light-emitting units.

After receiving the timing control data, the control chips of the light-emitting units can extract the control data corresponding to themselves, then generate corresponding light-emitting control signals based on the control data, and drive, by means of the light-emitting control signals, the LED packages of the light-emitting units to emit light according to the light-emitting color information and the light-emitting timing information in the control data. Each light-emitting unit is controlled to emit light according to the above mechanism, such that lighting effects can be displayed in a coordinated manner.

According to the above embodiments, it can be seen that under the action of the timing control data implemented based on the light-emitting unit mapping table in the present disclosure, the respective lighting modules are capable of parsing and executing the timing control data in a standardized manner, driving the corresponding light-emitting units to operate through the timing control data, and displaying the lighting effects defined in the lighting effect application package in a coordinated manner. It can be seen that even in the presence of a complex architecture including multiple layers, multiple lighting modules, multiple light-emitting regions, and multiple light-emitting units, the lighting effects can still be displayed effectively, thereby improving practical applicability of modular lighting fixtures and facilitating promotion thereof.

Based on any embodiment of the present disclosure, another embodiment of the present disclosure further provides a lighting effect signal generation device and a lighting effect display device. The lighting effect signal generation device and the lighting effect display device may be a modular lighting fixture, and a controller carried in the modular lighting fixture may be implemented based on a computer device, as shown in FIG. 16, which is a schematic diagram of an internal structure of the computer device. The computer device includes a processor, a computer-readable storage medium, a memory, and a network interface connected by a system bus. The computer-readable storage medium of the computer device stores an operating system, a database, and one or more computer-readable instructions. The database may store control information sequences, and the one or more computer-readable instructions, when executed by the processor, cause the processor to perform a method for displaying a lighting effect. The processor of the computer device is configured to provide computing and control capabilities to support running of the entire computer device. The memory of the computer device may store one or more computer-readable instructions, and the one or more computer-readable instructions, when executed by the processor, cause the processor to perform the method for generating a lighting effect signal and the method for displaying a lighting effect according to the present disclosure. The network interface of the computer device is configured to connect to and communicate with a terminal. Those skilled in the art can understand that the structure shown in FIG. 10 is only a block diagram of a portion of the structure related to the solutions of the present disclosure, and does not constitute a limitation on the computer device to which the solutions of the present disclosure are applied. Specifically, the computer device may include more or fewer components than those shown in the figure, or combine some components, or have different component arrangements.

The present disclosure further provides a storage medium storing one or more computer-readable instructions. The one or more computer-readable instructions, when executed by one or more processors, cause the one or more processors to perform the steps of the method for generating a lighting effect signal and the method for displaying a lighting effect according to any one of the embodiments of the present disclosure.

The present disclosure further provides a computer program product including one or more computer programs/instructions. The one or more computer programs/instructions, when executed by one or more processors, cause the one or more processors to perform the steps of the method for generating a lighting effect signal and the method for displaying a lighting effect according to any one of the embodiments of the present disclosure.

What is claimed is:

1. A method for generating a lighting effect signal, comprising:
acquiring a lighting effect application package, wherein the lighting effect application package comprises lighting-effect control parameters corresponding to a plurality of layers, and the lighting effect control parameters describe lighting effects of the corresponding layers in a tree-like multi-level data structure;
converting, according to a topological ordering relationship represented by a light-emitting unit mapping table corresponding to a modular lighting fixture, the lighting effect control parameters of each of the layers into timing control data, wherein the topological ordering relationship is used for characterizing a topological ordering relationship formed by respective lighting modules of the modular lighting fixture, respective light-emitting regions within each lighting module, and respective light-emitting units within each light-emitting region, according to multi-level connection relationships; and
outputting the timing control data to the respective lighting modules of the modular lighting fixture to control respective light-emitting control chips within the respective lighting modules to generate corresponding light-emitting control signals.

2. The method for generating a lighting effect signal according to claim 1, wherein acquiring the lighting effect application package comprises:
identifying, in response to a query instruction from a terminal device for acquiring topological information of the modular lighting fixture, topological information corresponding to a topological relationship formed by the respective lighting modules;
transmitting the topological information to the terminal device for allowing the terminal device to define the lighting effect control parameters corresponding to at least one layer; and
receiving, in response to a transmission instruction from the terminal device, the lighting effect application package generated by the terminal device based on the topological information.

3. The method for generating a lighting effect signal according to claim 2, wherein identifying the topological information corresponding to the topological relationship formed by the respective lighting modules comprises:
broadcasting an initialization instruction to the respective lighting modules of the modular lighting fixture;
responding, by each lighting module, to the initialization instruction to query connection states of respective connection interfaces of the lighting module, wherein the connection interfaces are arranged in the light-emitting regions of the lighting module;
generating, by each lighting module, connection information characterizing a topological ordering relationship among the respective light-emitting units in the respective light-emitting regions of the lighting module; and
orderly concatenating, by each lighting module, data packets received from downstream lighting modules via connection interfaces in an output state with the connection information of the lighting module to form a data packet of the lighting module, and transmitting the data packet to an upstream lighting module connected to the lighting module via a connection interface in an input state, such that a top-level lighting module outputs the data packet generated thereby as the topological information of the modular lighting fixture.

4. The method for generating a lighting effect signal according to claim 3, wherein after the top-level lighting module outputs the data packet acquired as the topological information of the modular lighting fixture, the method comprises:
parsing the topological information to acquire the corresponding connection information of each lighting module in the topological ordering relationship, and extracting, from each piece of connection information, electrical structure information within the corresponding lighting module, wherein the electrical structure information comprises identity identifiers and ordering identifiers of the respective light-emitting units in the lighting module, and region identifiers of the light-emitting regions to which the light-emitting units belong;
converting the electrical structure information of each lighting module into a two-dimensional data representation set that uses the light-emitting units as data record units and is ordered based on the ordering identifiers of the light-emitting units within the corresponding lighting module; and
orderly adding, based on ordering positions represented by the connection information of the respective lighting modules in the topological ordering relationship, the two-dimensional data representation sets corresponding to the respective lighting modules to the light-emitting unit mapping table.

5. The method for generating a lighting effect signal according to claim 1, wherein converting, according to the topological ordering relationship represented by the light-emitting unit mapping table corresponding to the modular lighting fixture, the lighting effect control parameters of each of the layers into timing control data comprises:
for each of the layers, generating, based on the light-emitting unit mapping table, a corresponding unit instruction table, such that each data record in the unit instruction table is used as control data for a corresponding light-emitting unit;
for each of the layers, marking, based on effective light-emitting regions specified in region information in the lighting effect control parameters of the layer, effectiveness of the respective light-emitting units within the respective light-emitting regions in the unit instruction table of the layer as corresponding extended fields in the unit instruction table;
for each of the layers, determining, based on lighting effect information in the lighting effect control parameters of the layer, light-emitting color information and light-emitting timing information of the respective light-emitting units within the respective light-emitting regions in the unit instruction table of the layer as corresponding extended fields in the unit instruction table; and
respectively converting the unit instruction tables of the respective layers into the timing control data with the light-emitting control chips in the light-emitting units as a control granularity.

6. The method for generating a lighting effect signal according to claim 5, wherein outputting the timing control data to the respective lighting modules of the modular lighting fixture comprises:
acquiring layer information in the lighting effect control parameters of each layer in the lighting effect application package, and adjusting, according to a priority order defined in the layer information of the respective layers, a transmission order of the timing control data of each layer;
performing data compression on the timing control data of the respective layers whose transmission orders are adjusted; and
transmitting, according to the transmission orders, the compressed timing control data of the respective layers to the corresponding lighting modules of the modular lighting fixture.

7. The method for generating a lighting effect signal according to claim 1, wherein after outputting the timing control data to the respective lighting modules of the modular lighting fixture, the method comprises:
parsing and extracting, by a control unit of the lighting module that receives the timing control data, timing control data belonging to the lighting module in the timing control data, and acquiring timing control data of respective subsequent cascaded lighting modules;
transmitting, by the control unit, the timing control data of the respective subsequent cascaded lighting modules to downstream lighting modules through the connection interfaces of the lighting module; and
converting, by the control unit, the timing control data of the lighting module into control data corresponding to the respective light-emitting control chips within the lighting module, and transmitting the control data to the respective light-emitting control chips to control the corresponding light-emitting control chips to generate light-emitting control signals corresponding to the control data, thereby controlling corresponding light-emitting units to operate by means of the light-emitting control signals.

8. A method for displaying a lighting effect, comprising:
acquiring topological information of a modular lighting fixture, wherein the topological information characterizes a topological ordering relationship formed by respective lighting modules of the modular lighting fixture, respective light-emitting regions within each lighting module, and respective light-emitting units within each light-emitting region, according to multi-level connection relationships;
extending the topological information into a light-emitting unit mapping table by using the light-emitting units as data record units, and representing the topological ordering relationship in the light-emitting unit mapping table;
acquiring a lighting effect application package, wherein the lighting effect application package comprises lighting effect control parameters corresponding to a plurality of layers, parsing the lighting effect control parameters set for the layers in the lighting effect application package into control data corresponding to each light-emitting unit, and associating the control data with corresponding data records in the light-emitting unit mapping table to acquire unit instruction tables corresponding to the layers; and
converting the unit instruction tables into timing control data with control chips of the light-emitting units as a control granularity, and transmitting the timing control data to the respective lighting modules of the modular lighting fixture to display a lighting effect.

9. The method for displaying a lighting effect according to claim 8, wherein acquiring the topological information of the modular lighting fixture comprises:
broadcasting an initialization instruction to the respective lighting modules of the modular lighting fixture;
responding, by each lighting module, to the initialization instruction to query connection states of respective connection interfaces of the lighting module, wherein the connection interfaces are arranged in the light-emitting regions of the lighting module;
generating, by each lighting module, connection information characterizing a topological ordering relationship among the respective light-emitting units in the respective light-emitting regions of the lighting module; and
orderly concatenating, by each lighting module, data packets received from downstream lighting modules via connection interfaces in an output state with the connection information of the lighting module to form a data packet of the lighting module, and transmitting the data packet to an upstream lighting module connected to the lighting module via a connection interface in an input state, such that a top-level lighting module outputs the data packet generated thereby as the topological information of the modular lighting fixture.

10. The method for displaying a lighting effect according to claim 8, wherein extending the topological information into the light-emitting unit mapping table by using the light-emitting units as the data record units comprises:
parsing the topological information to acquire the corresponding connection information of each lighting module in the topological ordering relationship, and extracting, from each piece of connection information, electrical structure information within the corresponding lighting module, wherein the electrical structure information comprises identity identifiers and ordering identifiers of the respective light-emitting units in the lighting module, and region identifiers of the light-emitting regions to which the light-emitting units belong;
converting the electrical structure information of each lighting module into a two-dimensional data representation set that uses the light-emitting units as data record units and is ordered based on the ordering identifiers of the light-emitting units within the corresponding lighting module; and
orderly adding, based on ordering positions represented by the connection information of the respective lighting modules in the topological ordering relationship, the two-dimensional data representation sets corresponding to the respective lighting modules to the light-emitting unit mapping table.

11. The method for displaying a lighting effect according to claim 8, wherein parsing the lighting effect control parameters set for the layers in the lighting effect application package into the control data corresponding to each light-emitting unit, and associating the control data with the corresponding data records in the light-emitting unit mapping table to acquire the unit instruction tables corresponding to the layers comprise:
acquiring and parsing the lighting effect application package, wherein the lighting effect application package comprises the lighting effect control parameters corresponding to the plurality of layers, and the lighting effect control parameters comprise region information and lighting effect information;
for each of the layers, generating, based on the light-emitting unit mapping table, the corresponding unit instruction table, such that each data record in the unit instruction table is used as the control data for a corresponding light-emitting unit;
for each of the layers, marking, based on effective light-emitting regions specified in the region information in the lighting effect control parameters of the layer, effectiveness of the respective light-emitting units within the respective light-emitting regions in the unit instruction table of the layer as corresponding extended fields in the unit instruction table; and
for each of the layers, determining, based on the lighting effect information in the lighting effect control parameters of the layer, light-emitting color information and light-emitting timing information of the respective light-emitting units within the respective light-emitting regions in the unit instruction table of the layer as corresponding extended fields in the unit instruction table.

12. The method for displaying a lighting effect according to claim 8, wherein converting the unit instruction tables into timing control data with control chips of the light-emitting units as the control granularity, and transmitting the timing control data to the respective lighting modules of the modular lighting fixture to display a lighting effect comprise:
respectively converting the unit instruction tables corresponding to the respective layers in the lighting effect application package into corresponding timing control data, wherein the timing control data use the light-emitting units represented by data records in the unit instruction tables as a control granularity, and are marked with light-emitting color information and light-emitting timing information determined based on lighting effect information in the lighting effect control parameters of the layers to which the light-emitting units belong;
acquiring layer information in the lighting effect control parameters of each layer in the lighting effect application package, and adjusting, according to a priority order defined in the layer information of the respective layers, a transmission order of the timing control data of each layer to acquire final timing control data; and
transmitting the final timing control data to the corresponding lighting modules of the modular lighting fixture to drive the corresponding light-emitting units of the respective lighting modules to display a lighting effect in a coordinated manner.

13. The method for displaying a lighting effect according to claim 8, wherein converting the unit instruction tables into timing control data with control chips of the light-emitting units as the control granularity, and transmitting the timing control data to the respective lighting modules of the modular lighting fixture to display a lighting effect comprise:
respectively converting the unit instruction tables corresponding to the respective layers in the lighting effect application package into corresponding timing control data, wherein the timing control data use the light-emitting units represented by data records in the unit instruction tables as a control granularity, and are marked with light-emitting color information and light-emitting timing information determined based on lighting effect information in the lighting effect control parameters of the layers to which the light-emitting units belong;
acquiring layer information in the lighting effect control parameters of each layer in the lighting effect application package, and adjusting, according to a priority order defined in the layer information of the respective layers, the light-emitting timing information corresponding to the respective light-emitting units in the timing control data of each layer; and
concatenating, in units of the lighting modules, the timing control data of the respective layers, and transmitting merged timing control data to the corresponding lighting modules of the modular lighting fixture to drive the corresponding light-emitting units of the respective lighting modules to display a lighting effect in a coordinated manner.

14. The method for displaying a lighting effect according to claim 8, wherein after driving the corresponding light-emitting units of the respective lighting modules to display a lighting effect in a coordinated manner, the method comprises:
parsing and extracting, by a control unit of the lighting module that has received the timing control data, timing control data belonging to the lighting module in the timing control data, and acquiring timing control data of respective subsequent cascaded lighting modules;
transmitting, by the control unit, the timing control data of the respective subsequent cascaded lighting modules to downstream lighting modules through the connection interfaces of the lighting module; and
converting, by the control unit, the timing control data of the lighting module into control data corresponding to the respective light-emitting units within the lighting module, and transmitting the control data to the respective light-emitting units to control the corresponding light-emitting units to emit light according to the control data.

15. A modular lighting fixture, comprising a controller and a plurality of lighting modules, the plurality of lighting modules being connected in series and then connected to the controller, wherein the controller is adapted to perform at least one of: a lighting effect signal generation method and a lighting effect display method;
wherein the lighting effect signal generation method comprises:
acquiring a lighting effect application package, wherein the lighting effect application package comprises lighting-effect control parameters corresponding to a plurality of layers, and the lighting effect control parameters describe lighting effects of the corresponding layers in a tree-like multi-level data structure;
converting, according to a topological ordering relationship represented by a light-emitting unit mapping table corresponding to a modular lighting fixture, the lighting effect control parameters of each of the layers into timing control data, wherein the topological ordering relationship is used for characterizing a topological ordering relationship formed by respective lighting modules of the modular lighting fixture, respective light-emitting regions within each lighting module, and respective light-emitting units within each light-emitting region, according to multi-level connection relationships;
outputting the timing control data to the respective lighting modules of the modular lighting fixture to control respective light-emitting control chips within the respective lighting modules to generate corresponding light-emitting control signals; and
wherein the lighting effect display method comprises:
acquiring topological information of a modular lighting fixture, wherein the topological information characterizes a topological ordering relationship formed by respective lighting modules of the modular lighting fixture, respective light-emitting regions within each lighting module, and respective light-emitting units within each light-emitting region, according to multi-level connection relationships;
extending the topological information into a light-emitting unit mapping table by using the light-emitting units as data record units, and representing the topological ordering relationship in the light-emitting unit mapping table;
acquiring a lighting effect application package, wherein the lighting effect application package comprises lighting effect control parameters corresponding to a plurality of layers, parsing the lighting effect control parameters set for the layers in the lighting effect application package into control data corresponding to each light-emitting unit, and associating the control data with corresponding data records in the light-emitting unit mapping table to acquire unit instruction tables corresponding to the layers; and
converting the unit instruction tables into timing control data with control chips of the light-emitting units as a control granularity, and transmitting the timing control data to the respective lighting modules of the modular lighting fixture to display a lighting effect.
